(19) United States
(12) Patent Application Publication
(10) Pub. No.: US 2006/0243756 A1
(43) Pub. Date: Nov. 2, 2006

(54) Gravity-fed liquid chemical dispensing bottle

(76) Inventor: Kevin Kawakita, Temple City, CA (US)

Correspondence Address: KEVIN KAWAKITA, 5812 TEMPLE CITY BL. #100, TEMPLE CITY, CA, 91780, US

(21) Appl. No.: 11/451,547

(22) Filed: Jun. 12, 2006

Related U.S. Application Data
(63) Continuation-in-part of application No. 09/837,314, filed on Apr. 19, 2001, now abandoned.
(60) Provisional application No. 60/256,103, filed on Dec. 18, 2000.

(51) Int. Cl. B67D 3/00

(52) U.S. Cl. 222/478; 222/185.1

(57) ABSTRACT

The abstract figure shows a gravity-fed liquid chemical dispenser bottle (100) with a broad representation of gravity feed features used for an extremely viscous chemical, which stops the irritating wait for a bottle turned upside down to dispense thick liquid chemical (204) such as condiments, pharmaceuticals, motor oil, etc especially with a low bottle, furthermore, many advantages accrue to this design including no human user flip container action leading to long impatient user waits and messy spills, very little chemical waste from side and bottom cling, no air dispensing and non-emulsified liquid dispensing, furthermore, the device consists of a glass or squeezable plastic bottle shaped like a prior art ketchup bottle having a twist ventilation only cap (102) on top of the bottle, a one-way trapdoor diaphragm (103) or one-way diaphragm mechanism to prevent spills and liquid chemical (204) dispensing from the top, a real bottle top with ventilation hole (104) with top-end neck, a liquid chemical bottle body (106) with bottom-end neck, a real bottle bottom with nozzle (108) or nozzle fitting, a flip-off/flip-on nozzle cap (110), and a false bottle bottom or stand (112) with an opposing end anti-drip cap

### CROSS REFERENCES TO THE PRESENT INVENTOR'S RELATED PATENT APPLICATIONS

None.

### BACKGROUND OF THE INVENTION

### Field of the Invention

This invention relates to food container packaging and dispenser bottles in particular to condiment dispenser bottles (e.g. ketchup bottles, thick salad dressing bottles, mustard bottles, relish bottles, mayonnaise bottles, etc.).

This invention also relates to pharmaceutical and cosmetic packaging and dispenser bottles (e.g. hand and body lotion bottles, shampoo bottles, liquid soap bottles, perfume bottles, etc.).

This invention also relates to automobile chemical packaging and dispenser bottles (e.g. motor oil bottles, anti-freeze bottles, hydraulic fluid bottles, transmission fluid bottles, anti-freeze bottles, fuel-injection cleaner bottles, gas and oil treatment bottles, etc.).

This invention also relates to household chemical packaging and dispenser bottles (e.g. glass cleaner spray bottles, tile cleaner spray bottles, etc.).

Patent Class: Utility Patent in the Machine Class.

Patent Subclass:

Disposable liquid chemical packaging and dispensing devices

Disposable food packaging devices.

Disposable cosmetic and pharmaceutical packaging devices.

Disposable auto chemical devices.

Disposable household chemical packaging devices.

Cross-reference To The Present Inventor's Related Issued U.S. patents:

None.

References: to Other U.S. patents

U.S. Pat. No. 1,660,606. Date of Issue: Feb. 28, 1928, Filing Date: Apr. 19, 1926, Issued to: Evans, Hopkins

U.S. Pat. No. 2,779,472. Date of Issue: Jan. 29, 1957, Filing Date: Apr. 6, 1953, Issued to: Febbraro, Mario.

U.S. Pat. No. 4,428,507. Date of Issue: Jan. 31, 1984, Filing Date: Jun. 21, 1982, Issued to: Sneider, Vincent R.

U.S. Pat. No. 4,516,697. Date of Issue: May 14, 1985, Filing Date: Sep. 22, 1982, Issued to: Dreps, James R.

U.S. Pat. No. 4,762,241. Date of Issue: Aug. 9, 1988, Filing Date: Feb. 5, 1987, Issued to: Lang, Richard R.

U.S. Pat. No. 4,930,668. Date of Issue: Jun. 5, 1990, Filing Date: Feb. 2, 1989, Issued to: Krall, Thomas J.

U.S. Pat. No. 5,033,655. Date of Issue: Jul. 23, 1991, Filing Date: Apr. 25, 1989, Issued to: Brown, Paul E.

U.S. Pat. No. 5,060,830. Date of Issue: Oct. 29, 1991, Filing Date: Jan. 11, 1990, Issued to: Krall, Thomas J.

U.S. Pat. No. 5,133,482. Date of Issue: Jul. 28, 1992, Filing Date: Nov. 28, 1990, Issued to: Burrows, Bruce D.

U.S. Pat. No. 5,141,136. Date of Issue: Aug. 25, 1992, Filing Date: Jan. 25, 1991, Issued to: Tignor, Jeffrey H.

U.S. Pat. No. 5,421,488. Date of Issue: Jun. 6, 1995, Filing Date: Jun. 17, 1994, Issued to: Ehrbar, James J.

U.S. Pat. No. 5,482,172. Date of Issue: Jan. 9, 1996, Filing Date: Sep. 16, 1993, Issued to: Braddock, Calvin C.

U.S. Pat. No. 5,626,262. Date of Issue: May 6, 1997, Filing Date: Jan. 7, 1995, Issued to: Fitten, Timothy E.

U.S. Pat. No. 5,655,687. Date of Issue: Aug. 12, 1997, Filing Date: Jan. 7, 1995, Issued to: Fitten, Timothy E.

U.S. Pat. No. 5,819,984. Date of Issue: Oct. 13, 1998, Filing Date: Jan. 23 1997, Issued to: Krueger, Kurtis W.

U.S. Pat. No. 5,868,288. Date of Issue: Feb. 9, 1999, Filing Date: Feb. 21 1997, Issued to: Redmond, Thomas M. Sr.

U.S. Pat. No. 6,161,737. Date of Issue: Dec. 19, 2000, Filing Date: Feb. 2, 1999, Issued to: Leary, Cornelius F.

U.S. Pat. No. 6,494,346. Date of Issue: Dec. 17, 2002, Filing Date: Jan. 25, 2001, Issued to: Gross, Richard A.

U.S. Pat. No. 315,096. Date of Issue: Mar. 5, 1991, Filing Date: Jan. 12, 1987, Issued to: Rocchio, Chris A.

References To Foreign Patents: None

References To Non-patent Literature:

[REF 4] Crown, Cork and Seal, “Crown, Cork and Seal Annual Report for 2000 [containing company product descriptions for consumer packaging],” published by Crown, Cork and Seal as public stock holder information, Philadelphia, Pa. (headquarters), 2001.

NOTE: Serving as ‘prior art’ of original patent filing date, on industry standard plastics fitting or plastic closure technology.

[REF 8] Crown, Cork and Seal, “Crown, Cork and Seal Annual Report for 2001 [containing company product descriptions for consumer packaging],” published by Crown, Cork and Seal as public stock holder information, Philadelphia, Pa. (headquarters), 2002.

NOTE: Serving as ‘post art’ of original patent filing date, but, prior art to the CIP patent filing date, on industry standard plastics fitting or plastic closure technology.

WEB SITE DATA WITH FAST-CHANGING INFORMATION (PRINT-OUT MATERIAL OF WEB SITES DATED BOTH BY PRINT-OUT PERSONAL COMPUTER INSERTED, DATES, AND ALSO SECONDLY BY USING PRESENT APPLICANT SIGNED OATH OR AFFIRMATION AS TO THE INTEGRITY OF THE WEB SITE PRINT-OUTS AND THE PRINT-OUT DATING METHOD)

[REF 20] Heinz Corporation, “Web Site with Information on No Wait, No Mess (R), Bottom Dispensing, Personal Sized, Easy Squeeze (R) Ketchup Bottle,” Heinz Corporation Corporate Office publication, Aug. 28, 2002.

NOTE: Serving as ‘post-art’ of original patent filing date, on personal sized, bottom dispensing bottles, [with present inventor oath or declaration for documenting the integrity of print-outs of fast-changing Web site data which are Web site embedded text dated as entries for: Aug. 28, 2002, Sep. 17, 2002, and May 20, 2003, and present inventor's computer print-out computer time dated to Jul. 5, 2003].

[REF 24] Crown-Zeller Division, “Web Site with Plastics Injection Molding Products For Consumer Plastics Packaging,” Crown-Zeller Division Web publication, Jan. 12, 2005.

NOTE: Serving as ‘post-art’ of original patent filing date, on personal sized, bottom dispensing bottles and bottom dispensing tubes, [with present applicant oath or declaration for documenting the integrity of print-outs of fast-changing Web site which are not Web site embedded text information dated due to having no date text, and present applicant's computer print-out computer time dated to Jan 12, 2005].
U.S. Pat. No. 6,161,737
Date of Issue: Dec. 19, 2000
Filing Date: Feb. 2, 1999
Issued to: Leary, Cornelius F.

This Leary patent covers a bottom dispensing, household sized, rectangular shaped, liquid chemical packaging dispenser with a built-in handle on top and a flip-down, side-mounted nozzle. The flip-down motion opens and closes the nozzle.

This Leary patent does not have a dedicated, top mounted ventilation hole protected by a one-way diaphragm which allows air down, but, does not allow liquid to move up. The present inventor's invention includes such as valve. This dedicated, top mounted ventilation hole is necessary for proper efficient dispensing in order to avoid production of a vacuum inside the container with continuous dispensing actions. Otherwise, air must enter from the bottom spout after one, dispensing, liquid squeeze uses up the available air in the closed container. Interrupted dispensing actions allow air to come back up through the single bottom spout in a “hiccup” action with non-viscous liquids and failed operation with viscous liquids causing the user to turn the bottle right-side up which clears viscous liquid out of the bottom nozzle. The Leary patent has no means whatsoever for top ventilation while dispensing from the bottom nozzle.

Unlike the present applicant's invention, this Leary patent also does not have a drip catching removable bottom piece, so, liquid drips will fall on a table or floor, also this Leary patent mentions no recessed bottom with a built-in, stand to cover the bottom-nozzle and bottom-cap.
U.S. Pat. No. 5,868,288
Date of Issue: Feb. 9, 1999
Filing Date: Feb. 21, 1997
Issued to: Redmond, Sr. et al. (of Redmond Products Inc.)
Assigned to: Bristol-Meyers Squibb Company

This Redmond patent covers a bottom dispensing, personal sized, specified and drawn perfectly symmetrically round in cross-section and cylindrical in bottom-dispensing bottle shape, through the specified use of ‘alignment lugs,’ used in fully automated, labeling and printing operations only for perfectly round container alignment by automatic filling and labeling machines such that the direct printed labeling on plastic bottles, will not cross a vertical bottle seam, and ‘positioning lugs’ used in fully automated, bottle top assembly factory operations with an un-capped bottle opening facing upwards bottle, undergoing liquid chemical filling operations with the downwards force of gravity aided machine injection pressure, followed by an automated top-down capping operation using factory capping machinery, followed by an automated side-ways spraying direct ink labeling operation using factory direct ink jet spray machinery, thus only perfectly round or cylindrical containers need alignment aids for the bottling machines. The Redmond patent describes a liquid chemical packaging dispenser with a semi-permanent, screw-on, dispensing cap upon the bottom of the bottle in the gravity-fed, normal dispensing position. The Redmond Sr. patent is an independent patent, but, technically is based upon the two preceding Fitten patents (see below), both Fitten patents being subsequent to U.S. patent filing date, assigned to Redmond Products, associated with Mr. Redmond, Sr., a major well known, corporate owner in the consumer hair care products industry. The lower in U.S. patent sequence number, Redmond Sr. patent, one of two filed on the same day with the second patent being identical in every way, except having a screw-on ‘travel cap’ which removes from the bottom dispensing bottom and screws onto the non-bottom dispensing top of bottle, has no removable bottom cap, ‘travel cap,’ of the second Fitten patent (U.S. Pat. No. 5,655,687) which screw attaches to the top of the bottle when in the normal bottom dispensing position, and screw attaches to the bottom of the bottom dispensing bottle, only when in the travel position, while the first Fitten patent (U.S. Pat. No. 5,626,262) filed on the same day as the second Fitten patent, has no removable, screw action removable bottom cap (“travel cap”). The Redmond Sr. patent has a factory built-in, gravity dispensing, quad-cusped valve (four-flapped valve or cross-slit valve compared to a heart valve which is a tri-cuspid valve) or some other form which does not require dispensing cap removal for liquid bottom dispensing, since there is no removable bottom cap (“travel cap” of only the first Fitten patent) to use as a covering structural mechanism while in storage or travel. The use of the Redmond Sr. patent's striped appearing indentations in the plastic (‘alignment lugs’) on the usually soft squeeze plastic bottle sides, is required only for perfectly symmetrically round cross-section bottles, for use by automated factory alignment equipment where the bottle is factory-time only aligned with its normal either top or bottom dispensing end facing towards the factory ceiling for a fully automated, machine aligning operation and then machine labeling or else direct printing operation. The ‘alignment lugs’ along the perfectly cylindrical bottle's sides are used for automatic bottle alignment only in machines putting the labeling on the correct position to miss the two side seams, having no other optical means of alignment to avoid placing a label or direct printing upon the two seams on the bottle sides. A fully automated machine ‘liquid [top] filling operation’ for bottling follows injecting liquid chemical into the un-capped bottle placed open tube side pointed towards the ceiling. A fully automated machine top capping operation follows which is usually a female screw-on ‘plastic closure’ or ‘plastic fitting’ onto the male screw thread on the outer neck of the bottle. A perfectly cylindrical bottle only will need two ‘positioning lugs’ near the neck of the bottle opening in the Redmond Sr. patent which are two indentations near the bottle neck used for automated cap assembly, and are not necessary for non-symmetric bottle tops which give alignment information from non-symmetric shape. The liquid filled, bottom dispensing bottle (gravity bottle) is in an assembly line upside down from the normal dispensing use position in gravity-fed dispensing with the uncapped, open bottle facing towards the ceiling, and automated factory capping equipment first aligns the top of the bottle using the Redmond Sr. patent's designed two ‘positioning lugs’ and then attaches the cap from the top. An automatic direct print labeling operation typically follows on the same production line which ink jet prints directly upon the already injection molded bottle plastic of the bottle, an upside-down label for a bottom dispensing bottle, and a right-side up label for a top dispensing bottle. The Redmond Sr. patent is invented by the same invention team as the two earlier Fitten patents and is very similar in size and function following several Fitten U.S. design patents. This Redmond Sr. patent in its normal, gravity-fed, dispensing position does not have a removable anti-drip cap (“travel cap”) of the first Fitten patent, which also functions as a table stand on its bottom end, also as either a primary or secondary anti-drip catching receptacle on its opposite end, also as an anti-oxidation and anti-chlorinated water from tap water unit rinsing sealed tight cap which is a big disadvantage in actual use, unlike the present applicant's preferred embodiment invention. A secondary anti-drip containment removable lid as a design option is missing in the Redmond Sr. patent which could contain unavoidable drips. The Redmond Sr. patent is an independent USPTO patent, but, is technically derived from the earlier USPTO filed, two Fitten patents which were both assigned to Redmond Products. Any drips in the Redmond Sr. patent will end up on the table or counter, on the floor, or on the medicine cabinet, and accumulated drips on the non-removable in normal use, bottom of the Redmond, Sr. dispensing cap will also collect unsightly and un-hygienic dirt and dust. This dirt and dust problem will necessitate either expensive anti-tamper sealing or a cardboard box for store retail sale due to customer attempts to squeeze the bottle. At home customer use of the bottle in its normal gravity-fed dispensing position exposes the dispensing cap to dust and dirt accumulation which is un-hygienic. Customer attempts at washing off the unavoidable accumulated dust and dirt coming from normal use will result in water entering the container especially if the container is squeezed during washing. The Redmond Sr. structure in the normal gravity-fed dispensing operation is not water-tight due to the pressure sensitive, quad-cusped, silicone valve on the semi-permanently screwed on, bottom dispensing cap. The hermetic sealing of the quad-cusped, silicone valve on the bottom positioned dispensing cap is unknown which might be required for chemical anti-oxidation considerations at all times even on the store shelf. This Redmond Sr. patent specifies through the use of both “alignment lugs (for labeling and bottle printing)” and “positioning lugs (for automatic capping)” a perfectly round cross-section, cylindrical bottle which furthermore must have an equal diameter on the bottom and the top of the bottle which is not the optimum shape for a bottom dispensing, anti-top heavy, designed bottle. A cylindrical container clearly rules out an optimized anti-top heavy design which should be of greater diameter at the bottom and smaller diameter at the top. A perfectly round cap receptacle in the Redmond Sr. patent requiring “positioning lugs” is a major disadvantage. A perfectly symmetric in cross-section container rules out the patent's use for non-symmetric tube shapes which are usually oval in cross-section with varying cross-section diameter over length. Tubes in the factory are usually non-symmetric cross-section, elliptical structures which are open at one end with the opposing end having a male threaded, dispensing-end, single neck for ‘plastic closure’ or ‘plastic fitting’ attachment (e.g. Crest (R) toothpaste tube), whose first end is heat formed into a plastic nozzle with a male screw thread upon the outside of the nozzle, and then the plastic tube fitting or tube cap is hand or machine screwed onto the end of the tube. Then the tube with the top end still open for filling is placed dispensing-end, single neck side down in an assembly line with the open tube end pointing upwards for the fully automated tube, liquid fill operation. The tube seal operation is fully automated usually through machine crimping, and machine heat annealing of plastic using “heat seal lugs.” The Redmond Sr. patent's specified ‘alignment lugs’ and ‘positioning lugs’ require shape symmetry on the cross-section, cap-end, and top to bottom equal diameters of cross-sections, also prevents an anti-top-heavy design of top to bottom shape in the normal dispensing position.

By y. 2003, the present applicant has personally purchased, and field tested, actual US mass marketed product of a design exactly given by the Redmond Sr. patent found in an ‘Aussie Hair Care (R)’ branded Redmond Products shampoo and has verified this description.

The present applicant's invention avoids the many problems of the Redmond Sr. patent involving the cumbersome ‘travel cap’ which is simply not designed for easy on and easy off, non-travel use with the bottle stored on a medicine cabinet or a bathroom counter in a bottom dispensing end facing down position, while the present applicant's invention retains the goal of easy, fully automated manufacturing operations. The present applicant's patent stops liquid chemical oxidation, UV light exposure, possible air-born bacterial, yeast, and flying and crawling insect infestation, unwanted drips, dirt and dust accumulation, and is easy to wash off at the faucet as a completely closed both water tight and hermetically sealed unit with a more efficient bottom dispensing integral cap design.
U.S. Pat. No. 5,655,687
Date of Issue: Aug. 12, 1997
Filing Date: Jun. 7, 1995
Issued to: Fitten, Timothy E.
Assigned to: Redmond Products, Inc., Chanhassen, Minn.

This second Fitten patent (filed on the exact same day as the first Fitten patent mentioned just below, as a fully independent U.S. patent to cover a “travel cap” addition and travel cap attachment mechanism simply by a minor difference in claims writing for the exact same technical material and drawings) covers a bottom dispensing, personal sized, specified and also drawn equal perfectly round diameter on the top of the bottle and exactly matching perfectly round same diameter on the bottom of the bottle (to fit the travel cap on both ends), liquid chemical packaging dispenser with a factory assembled, semi-permanently screwed-on dispensing cap which is at the factory attached to the bottom of the bottle in the normal, gravity-fed, dispensing position and configuration. The semi-permanent dispensing cap or ‘plastic closure’ or ‘plastic closure’ has a glue attached inside the screw-on ‘plastic closure’ or ‘plastic closure,’ for use in a bottom dispensing (gravity bottle), user hand-squeeze of a soft plastic bottle, pressure activated, silicone cross-slit valve (quad-cusped valve), anti-drip valve which does not require dispensing cap removal for liquid chemical dispensing. The bottom-dispensing bottle in its normal use configuration rests directly with the dispensing cap (‘plastic closure’) resting on a table or counter-top with the separate “travel cap” being screwed on the top of the bottle and only used in transit and travel, hence its name, for closure of the bottom of the bottle, which requires a wide diameter and surface area for the dispensing cap (‘plastic closure’) to avoid the tipping over forces of gravity. The silicone, anti-drip, cross-slit valve (quad-cusped valve) glued in the internal center of the dispensing cap (‘plastic closure’) stops the liquid from dispensing with gravitational force unless the soft plastic bottle is squeezed by hand which opens up the valve with the valve closing by itself with removal of the hand squeezing pressure. A hand squeeze outtake stroke of liquid with plastic bottle deformation dispenses liquid chemical, while the intake stroke of outside air from plastic bottle reformation sucks in air to prevent a vacuum. This action is suitable for slightly viscous liquids, but, is not suitable for extremely viscous liquids such as house-hold white glues, and mustards. The dispensing cap (‘plastic closure’) must be round to make use of the Fitten patent detents (‘positioning lugs’) and is also required to be the same diameter as the travel cap. The round travel cap being used on both ends of the bottle, absolutely requires the same diameter at both the bottom of the cylindrical shaped bottle. Furthermore, the round travel cap being used on both ends of the bottle, requires a perfectly round diameter top and bottom of the bottle. Furthermore, the neck of the Fitten patent bottle has two indents (‘positioning indents’) used for automatic capping operation bottle alignment. The travel cap is attached to the top of the bottle in the normal use configuration and to the bottom of the bottle only in the travel configuration. The separate, screw-on, travel cap is specified for use only in covering the dispensing cap (‘plastic fixture’) in traveling or mobile transport of the Fitten container. This second Fitten patent's “travel cap” in its normal dispensing position and configuration is screwed out of the way temporarily when in use, onto the top of the bottle (requiring a perfectly round top of bottle with a top diameter equal to the bottom diameter) only while in intended dispensing position, and does not serve as an anti-drip cap with both water and hermetic sealing which could potentially also function as a permanent table stand on its dispensing or bottom end, which distinguishes the Fitten patents from the present inventor's preferred embodiment application. The normal dispensing Fitten patent bottom dispensing bottle when stored on a bathroom counter-top or medicine cabinet rests upon the permanently, built-in, dispensing cap (‘plastic fixture’) with the cross-slit silicone valve possibly leaking out non-emulsified liquids and also letting air intake through the silicone slit valve into the liquid chemical with oxidation damage to the liquid chemical, also with highly possible bacterial, virus, and even fragrance attracted insect contamination in the atmospheric air intake, also with highly possible dirt and dust contamination of the liquid chemical which will accumulate upon the unavoidable, exposed liquid chemical collected on the bottom of the dispensing cap (‘plastic fixture’). The present inventor's preferred embodiment's false bottle bottom or stand serves as a secondary drip catching receptacle on its bottom end giving permanent hermetic seal (with air born bacteria and viral protection and liquid chemical oxidation damage), permanent water sealing, permanent dirt and dust sealing, permanent light and subset UV sealing, and permanent odor and fragrance sealing protection to the liquid chemical. Therefore, the Fitten patent will allow unavoidable unsightly floor drips and table drips as well as accumulation of dirt and dust on the un-capped dispensing cap (‘plastic fixture’) with the further problem of losing a hermetic seal to prevent liquid chemical oxidation whenever the liquid chemical is not in use. The resulting problem of a non-hermetic seal being oxidation and possibly chlorinated water damage particularly undesired for food and pharmaceuticals due to gradually breaking down almost all chemicals at different rates. The effects of UV light exposure also breaks down liquid chemical depending upon molecular chemistry compositions. Oxidation and UV light with a food supply are necessary for many aerobic bacterial, yeast, and insect multiplication processes. Continuous oxidation produces either odors or fragrances which can either be from the liquid chemical or from bacterial by-products. Anaerobic bacteria reproduce without oxygen and are often killed by both oxygen and UV light exposure. The use of a Fitten patent “travel cap” vs. the present inventor's false bottle bottom or drip-cap stand introduces sanitation problems with accumulations of dirt and dust and possible bacterial contamination problems in the Fitten patent. The Fitten patent “travel cap” does not serve the purpose of hermetic seal, drip catching, anti-dirt and anti-dust accumulation plus ease of chlorinated tap water washing off of the sealed unit, because the “travel cap” is screw-attached to the top of the container in the normal dispensing configuration. The Fitten patent top attachment position will leave unsightly and sticky liquid chemical on the top of the plastic bottle which will also attract dirt, dust, and dangerous bacteria which will be picked up in an undesirable manner on customer's hands and also on other contacted close objects with continued travel cap use. The Fitten patent top of bottle has no guarantees of hygienic condition before travel cap attachment to begin with accumulated dust, bacteria, and viruses being highly probable. Furthermore, if the Fitten patent travel cap was used as an anti-drip cap, liquid chemical would end up eventually in an undesired and potentially messy, unhygienic, and possibly bacterial prone manner on the top of the container. A secondary anti-drip containment valve in addition to the cross-slit valve as a design option is missing in the Fitten patent to fully contain the potentially messy and unavoidable drips from bottom dispensing operation of very low viscosity liquid chemical. Any drips will end up on the table or counter, on the floor, or on the medicine cabinet, and drips on the bottom of the Fitten patent in the normal use position and configuration will also collect unsightly and unhygienic dirt and dust. It is assumed that the travel cap will be in the travel configuration screwed upon the bottom of the bottle at the retail store sale. This dirt and dust potential problem with customer's trying out the product at the store will necessitate either expensive anti-tamper sealing or a sealed cardboard box for store retail sale. Tamper sealing is used only for food products and prescription drugs, but, not common pharmaceuticals used externally which customer's like to test sample before buying. Customer attempts at washing off the unavoidable accumulated dust and dirt coming from normal use in the normal use position and configuration will result in water entering the container through the cross-slit, silicone valve (not water-tight and not air-tight) especially if the container is squeezed during washing. The Fitten patent structure in the normal use configuration is not water-tight and not light and UV tight, and is not suitable for pharmaceuticals and ointment medications due to hygienic problems with dust, dirt, and germs. The hermetic sealing of the cross-slit silicone valve inside the dispensing cap (‘plastic closure’) is not complete which means chemical oxidation considerations in the normal use position and configuration. This second Fitten patent specifies through patent claims use of the travel cap on both the bottom and top of the container, that the travel cap diameter must equal the bottom of the container's diameter which must equal the top of the container's diameter. This requirement means that a maximized anti-top heavy design is not possible. This shape requirement also rules out the use of tubes in the Fitten patent. Tubes in the factory are usually non-symmetric cross-section structures which are open on both ends, whose first end is hand or machine closed through use of the plastic tube fitting or tube cap, and then placed upside-down in an assembly line with the open tube end pointing upwards for the fully automated liquid fill, and tube seal operation usually through heat annealing of plastic using “heat seal lugs.” The specified normal use configuration of the “travel cap” being on the top of the container with the container resting on the dispensing cap upon a table or counter-top means that the dispensing cap (‘plastic closure’) as well as the travel cap must have a broad base for stability. The two relatively large diameter structures mean maximized material cost which will make the Fitten container uneconomic for a disposable container, but, is suitable for a re-usable container or luxury item container.

The present applicant's patent avoids the many known problems of the two Fitten patents through a major advancement in bottom dispensing container technology, being the false bottle bottom or stand which is not an add-on after-thought, but, designed integral to the bottle mechanism. The present applicant's patent stops liquid chemical oxidation, UV light exposure, possible air-born bacterial, yeast, and flying and crawling insect infestation, unwanted drips, dirt and dust accumulation, and is easy to wash off at the faucet as a completely closed both water tight and hermetically sealed unit.
U.S. Pat. No. 5,626,262
Date of Issue: May 6, 1997
Filing Date: Jun. 7, 1995
Issued to: Fitten, Timothy E.
Assigned to: Redmond Products, Inc., Chanhassen, Minn.

This first of two Fitten patents (U.S. Pat. No. 5,626,262) without a bottom end, detachable covering cap (“travel cap”) where the bottom as defined as the normal intended dispensing position of the end with greatest gravitational weight, is also followed by a second Fitten patent (U.S. Pat. No. 5,655,687) filed on the exact same day with a “travel cap” with “travel cap” attachment mechanism, and also by several subsequent independent Fitten, U.S. design patents, and a subsequent technical development with the Redmond Sr. patent (U.S. Pat. No. 5,868,288) after both Fitten patents were assigned to Redmond Products (R) Incorporated, a major US hair-care corporation. The first USPTO filed Fitten patent covers a personal sized, bottom dispensing, squeeze container without a travel cap, with the “travel cap” used only in the second USPTO Fitten patent which screw attaches to the top of the bottle in normal bathroom dispensing position and use, and screw attaches to the bottom of the bottle only in travel use.

The first Fitten patent although it does not use a “travel cap” or a top male screw attachment for a “travel cap” is burdened by the same perfectly cylindrical design with the top diameter equaling the bottom diameter despite middle shape, which is why there is a need for ‘positioning lugs’ which is to align a perfect cylinder for bottle labeling (in this case applied upside-down) and bottle capping operations (in this case applied to the bottom of the bottle). The first Fitten patent, is a bottom dispensing bottle with human squeezing action on the bottle body, a liquid chemical packaging dispenser with a factory assembled, semi-permanently attached, dispensing cap (‘a plastic closure’) which is at the factory semi-permanently screw-on attached to the bottom of the bottle body in the normal dispensing position and configuration of gravity-fed operation. The semi-permanent factory screwed into position, dispensing cap (‘plastic closure’) has an internal to its dispensing end, glue attached through a central positioned hole, gravity-fed and squeeze dispensing, pressure fed, silicone cross-slit (quad-cusped valve), anti-drip valve. The dispensing cap (‘plastic closure’) is not removed in dispensing operation and has no form of covering or travel cap (added to the other Fitten U.S. Pat. No. 5,655,687 filed upon the same day which also had near the neck ‘positioning detents’ for automatic cap attachment in a perfectly round bottle). The dispensing cap (‘plastic closure’) rests directly upon a flat surface such as a table or counter. One embodiment of the Fitten patent adds a tiny protruding circular ridge which runs around the perimeter of the dispensing cap (‘plastic closure’), done to create a circular dam to catch excess fluid flow meant to stop stains upon the table or counter. An entirely separate Fitten patent with a “travel cap” was filed on the same day to solve the problem of stains upon the table or counter and to give a hermetic seal while traveling or in transit. The first Fitten patent having no travel cap is obviously defective with regards to staining tables and counters from unavoidable and unwanted liquid chemical drips, oxidation problems and UV light break-down of liquid chemical since the travel cap may be a hermetic seal but the cross-slit silicone valve is not a hermetic seal, un-hygienic accumulations of dirt and dust and possibly bacteria upon the exposed liquid chemical left on the plastic closure, and also leaks from accidental bottle squeezing. The second Fitten patent with a travel cap was filed on the same day as this first Fitten patent. The fact that the dispensing cap (‘plastic closure’) with it internal glue attached, central, silicone cross-slit valve rests directly upon a table or counter necessitates a rather large cylindrical structure for anti-stability from forced, non top-heavy design which means a large amount of material and cost.

The second Fitten USPTO patent (see just above) is unlike this first USPTO Fitten patent filed the same day, only in terms of technical material and claims affecting the added “travel cap” and the “travel cap” attachment mechanism on the top of the Fitten perfectly, cylindrical bottle. The second Fitten patent has both a “travel cap” which screw attaches to the top of the container in the normal dispensing position by means of male screw-threads on the perfectly cylindrical top of the container in normal dispensing position, and also screw attaches to male screw thread on the perfectly cylindrical bottom of the container in normal dispensing position only when the “travel cap” is placed there for travel use. The second Fitten container in technical drawings and specifications is required to be perfectly cylindrical due to “travel cap” use, and furthermore, the top diameter must exactly match the bottom diameter of the bottle in a perfect cylinder at the ends despite the middle shape, thereby, severely restricting anti-top heavy design efforts.

The present applicant's patent is a major technical advancement over and avoids the many known problems of the two Fitten patents being that the false bottle bottom or stand, is not an add-on after-thought, but, designed integrally into the bottle's bottom. The present applicant's patent stops liquid chemical oxidation, UV light exposure, possible air-born bacterial, yeast, and flying and crawling insect infestation, unwanted drips, dirt and dust accumulation, and is easy to wash off at the faucet as a completely closed both water tight and hermetically sealed unit.
U.S. Pat. No. 5,482,172
Date of Issue: Jan. 9, 1996
Filing Date: Sep. 16, 1993
Issued to: Braddock, Calvin C.

This Braddock patent covers a symmetric, either top dispensing, or bottom dispensing, rectangular shaped, household sized, liquid chemical packaging dispenser with a flip-cap exposed, top nozzle and a flip-cap exposed, bottom nozzle. The liquid chemical held inside the rectangular shaped, dispenser can flow to either nozzle as there is no preferred top or bottom side.

This Braddock patent does not have a dedicated, top mounted ventilation hole protected by a one-way diaphragm which allows air down, but, does not allow liquid to move up. The present applicant's invention includes such a valve. This dedicated, top mounted ventilation hole in as in the present inventor's preferred embodiment intended for extremely viscous liquid chemicals is necessary for proper efficient dispensing in order to avoid production of a vacuum inside the container with continuous dispensing actions. Otherwise, air must enter from the bottom spout after one, dispensing, liquid squeeze uses up the available air in the closed container. Interrupted dispensing actions allows air to come back up through the single bottom spout in a “hiccup” action with non-viscous liquids and failed operation with viscous liquids causing the user to turn the bottle right-side up which clears viscous liquid out of the bottom-nozzle.

This Braddock patent will allow use of the current top nozzle as an air intake nozzle even when it is not designed or specified for this purpose while the liquid dispensing occurs on the current bottom nozzle. The drawback of this Braddock design is that viscous and air hardened, liquid chemical will in all probability clog the current top nozzle blocking the air intake of a duo-use nozzle.

Unlike the present applicant's invention, this Braddock patent also does not have a drip catching removable bottom piece, so, liquid drips will fall on a table or floor, also this Braddock patent mentions no recessed bottom with a built-in, stand to cover the bottom-nozzle and bottom-cap.
U.S. Pat. No. 5,421,488
Date of Issue: June 6, 1995
Filing Date: June 17, 1994
Issued to: Ehrbar, James J.

This Ehrbar patent covers a symmetric, either top dispensing, or bottom dispensing, cylindrical shaped, household sized, liquid chemical packaging dispenser with a flip-cap exposed, top nozzle and a flip-cap exposed, bottom nozzle. The liquid chemical cavity inside the cylindrical shaped, dispenser can flow to either nozzle as there is no preferred top or bottom side.

This Ehrbar patent does not have a dedicated, top mounted ventilation hole as in the present inventor's preferred embodiment for extremely viscous liquid chemicals protected by a one-way diaphragm which allows air down, but, does not allow liquid to move up. The present applicant's invention includes such a valve. This top mounted ventilation hole is necessary for proper efficient dispensing in order to avoid production of a vacuum inside the container with continuous dispensing actions. Otherwise, air must enter from the bottom spout after one, dispensing, liquid squeeze uses up the available air in the closed container. Interrupted dispensing actions allows air to come back up through the single bottom spout in a “hiccup” action with non-viscous liquids and failed operation with viscous liquids causing the user to turn the bottle right-side up which clears viscous liquid out of the bottom-nozzle.

This Ehrbar patent will allow use of the current top nozzle as an air intake nozzle even when it is not designed or specified for this purpose while the liquid dispensing occurs on the current bottom nozzle. The drawback of this Ehrbar, design is that viscous and air hardened, liquid chemical will in all probability clog the current top nozzle blocking the air intake of a duo-use nozzle.

Unlike the present applicant's patent, this Ehrbar patent also does not have a drip catching removable bottom piece, so, liquid drips will fall on a table or floor, also this Ehrbar patent mentions no recessed bottom with a built-in, stand to cover the bottom-nozzle and bottom-cap.
U.S. Pat. No. 5,141,136
Date of Issue: Aug. 25, 1992
Filing Date: Jan. 25, 1991
Issued to: Tignor, Jeffrey H.

This Tignor patent covers a house-hold, viscous liquid dispensing, plastic bottle with an open top having a removable cap and a sealed bottom with a nozzle and removable cap which bottom-nozzle and bottom-cap are contained within a recessed formation which also serves as a built-in, bottle stand. The liquid chemical held inside the bottle shaped, dispenser can flow to either top or bottom nozzle with top dispensing used most of the time and bottom dispensing used when the bottle is low with liquid chemical.

This Tignor patent does not have a dedicated, top mounted ventilation hole protected by a one-way diaphragm which allows air down, but, does not allow liquid to move up. The present applicant's invention includes such a valve. This dedicated, top mounted ventilation hole is necessary for proper efficient dispensing in order to avoid production of a vacuum inside the container with continuous dispensing actions. Otherwise, air must enter from the bottom spout after one, dispensing, liquid squeeze uses up the available air in the closed container. Interrupted dispensing actions allows air to come back up through the single bottom spout in a “hiccup” action with non-viscous liquids and failed operation with viscous liquids causing the user to turn the bottle right-side up which clears viscous liquid out of the bottom-nozzle.

This Tignor patent will allow use of the dual-use, removable, top cap as an air intake even when it is not designed or specified for this purpose while the liquid dispensing occurs on the single-use, bottom nozzle. Viscous and air hardened, liquid chemical will in all probability not clog or partially clog the Tignor design by blocking or reducing the air intake of a duo-use top cap if it is large enough. As specified in the design and legal claims of the Tignor patent, the top opening is covered by a removable cap. A removable cap is not the best choice for an air nozzle as the cap must be stored somewhere and re-fastened after use.

Unlike the present applicant's invention, this Tignor patent also does not have a drip catching removable bottom piece, so, liquid drips will fall on a table or floor, also this Tignor patent mentions a recessed bottom with a built-in, stand to cover the bottom-nozzle and bottom-cap.
U.S. Pat. No. 5,033,655
Date of Issue: Jul. 23, 1991
Filing Date: Apr. 25, 1989
Issued to: Brown, Paul E.

This Brown patent covers a house-hold, viscous liquid dispensing, squeezable, plastic bottle with a top having a small opening which is capped with a hand-activated, top-cap, a sealed bottom with a bottom-nozzle covered by various embodiments of pressure activated, self-sealing, self-opening and self-closing, bottom-caps which bottom-nozzle and bottom-cap is optionally contained within a recessed formation which also serves as a built-in, bottle stand. The dispenser works with either top or bottom dispensing of liquid chemical. The liquid chemical held inside the bottle shaped, dispenser flows by gravity to dispense from the top opening if the top cap is manually removed with a flipped over bottle. Alternatively, the liquid chemical is pressure forced out of the pressure activated bottom-nozzle. An optional snap-on, drip catching, bottom-cap safety cover is mentioned.

The Brown top opening has no stated design or legal claims mention of duo-use for liquid dispensing with a flipped over bottle with the top cap manually removed or air intake from the top opening with the bottle used in right-side up for bottom dispensing. In fact duo-use of the top cap for air intake in this design is physically impossible. If the top opening without a cap is used for air intake for right-side up, bottom dispensing, hand-squeezing pressure on the deformable sides of the bottle will not produce enough pressure to activate the pressure activated, self-sealing, bottom-nozzle. In bottom-feed operation, the top opening must be closed by manual sealing with the top cap to allow side pressure build-up to activate the pressure activated, self-sealing, bottom-nozzle.

This Brown patent does not have a dedicated, top mounted ventilation hole protected by a one-way diaphragm which allows air down, but, does not allow liquid to move up. The present applicant's invention includes such a valve. This dedicated, top mounted ventilation hole is necessary for proper efficient dispensing in order to avoid production of a vacuum inside the container with continuous dispensing actions. Otherwise, air must enter from the bottom spout after one, dispensing, liquid squeeze uses up the available air in the closed container. Interrupted dispensing actions allow air to come back up through the single bottom spout in a “hiccup” action with non-viscous liquids and failed operation with viscous liquids causing the user to turn the bottle right-side up which clears viscous liquid out of the bottom-nozzle.

This Brown patent will physically not allow dual-use of the top opening as an air intake opening or top dispensing opening. As mentioned in the design and legal claims of the Brown patent, the bottom nozzle must be of a pressure activated, self-sealing, self-opening and self-closing, design of various embodiments. The present applicant's invention does not have this design or legal claim. Furthermore, the Brown design will not work efficiently in continuous dispensing of non-viscous fluids and with one “squeeze” action with viscous liquids due to the absence of any form of top mounted ventilation hole.

Unlike the present applicant's invention, this Brown patent also describes optional use of a separate drip catching removable bottom piece, so, liquid drips will not fall on a table or floor, also this Brown patent mentions an optional recessed bottom with a built-in, stand to cover the bottom-nozzle and bottom-cap.
U.S. Pat. No. 4,762,241
Date of Issue: Aug. 9, 1988
Filing Date: Feb. 5, 1987
Issued to: Lang, Richard R.

This Lang patent covers a house-hold, viscous liquid dispensing, bottle with an top with a small opening having a removable cap and a sealed bottom with a nozzle and removable cap which bottle's bottom may be optionally sloped towards the rim-mounted bottom-nozzle and bottom-cap.

The liquid chemical held inside the bottle shaped, dispenser can flow to either top opening or bottom nozzle. Top dispensing is used most of the time with bottom dispensing used when the bottle is low with liquid chemical.

This Lang patent does not have a dedicated, top mounted ventilation hole protected by a one-way diaphragm which allows air down, but, does not allow liquid to move up. The present inventor's invention includes such a valve. This dedicated, top mounted ventilation hole is necessary for proper efficient dispensing in order to avoid production of a vacuum inside the container with continuous dispensing actions. Otherwise, air must enter from the bottom spout after one, dispensing, liquid squeeze uses up the available air in the closed container. Interrupted dispensing actions allows air to come back up through the single bottom spout in a “hiccup” action with non-viscous liquids and failed operation with viscous liquids causing the user to turn the bottle right-side up which clears viscous liquid out of the bottom-nozzle.

This Lang patent will allow use of the dual-use, top nozzle as an air intake opening even when it is not designed or specified for this purpose while the liquid dispensing occurs on the single-use, bottom nozzle. The drawback of this Lang design is that viscous and air hardened, liquid chemical will in all probability clog or partially clog the current top opening blocking or reducing the air intake of a duo-use nozzle. If the top opening is made large it will reduce such air blockage problems. As specified in the design and legal claims of the Lang patent, the top opening is covered by a removable cap A removable cap is not the best choice for an air opening as the cap must be stored somewhere and re-fastened after use.

Unlike the present applicant's invention, this Lang patent also does not have a drip catching removable bottom piece, so, liquid drips will fall on a table or floor, also this Lang patent describes a recessed bottom with a built-in, stand to cover the bottom-nozzle and bottom-cap.
U.S. Pat. No. 4,428,507
Date of Issue: Jan. 31, 1984
Filing Date: Jun. 21, 1982
Issued to: Sneider, Vincent R.

This Sneider patent covers a house-hold, viscous liquid dispensing, bottle with a cylindrical shape, accordion side-walls, closed top having a push-in, pull-out nozzle, and a sealed bottom with a nozzle and twist-open, twist-close spigot.

The Sneider liquid chemical held inside the cylindrical shaped, dispenser can flow to either top or bottom nozzle with top dispensing used most of the time and bottom dispensing used when the bottle is low with liquid chemical.

This Sneider patent does not have a dedicated, top mounted ventilation hole protected by a one-way diaphragm which allows air down, but, does not allow liquid to move up. The present inventor's invention includes such a valve. This dedicated, top mounted ventilation hole is necessary for proper efficient dispensing in order to avoid production of a vacuum inside the container with continuous dispensing actions. Otherwise, air must enter from the bottom spout after one, dispensing, liquid squeeze uses up the available air in the closed container. Interrupted dispensing actions allows air to come back up through the single bottom spout in a “hiccup” action with non-viscous liquids and failed operation with viscous liquids causing the user to turn the bottle right-side up which clears viscous liquid out of the bottom-nozzle.

This Sneider patent will allow use of the dual-use, top nozzle as an air intake nozzle even when it is not designed or specified for this purpose while the liquid dispensing occurs on the single-use, bottom nozzle. The drawback of this Sneider design is that viscous and air hardened, liquid chemical will in all probability clog or partially clog the current top nozzle blocking or reducing the air intake of a duo-use nozzle. If the top nozzle is made large it will reduce such air blockage problems.

Unlike the present applicant's invention, this Sneider patent also does not have a drip catching removable bottom piece, so, liquid drips will fall on a table or floor, also this Sneider patent describes a recessed bottom with a built-in, stand to cover the bottom-nozzle and bottom-cap.
U.S. Pat. No. 2,779,472
Date of Issue: Jan. 29, 1957
Filing Date: Apr. 6, 1953
Issued to: Fehbraro, Mario

This Febbraro patent covers a house-hold, liquid dispensing, bottle with an open top having a removable cap and a sealed bottom with a nozzle and removable cap which bottle's bottom has a built-in sediment trap for filtering liquids such as wine.

The liquid chemical held inside the bottle shaped, dispenser can flow to either top or bottom nozzle with top dispensing used most of the time and bottom dispensing used when the bottle is low with liquid chemical.

This Febbraro patent does not have a dedicated, top mounted ventilation hole protected by a one-way diaphragm which allows air down, but, does not allow liquid to move up. The present inventor's invention includes such a valve. This dedicated, top mounted ventilation hole is necessary for proper efficient dispensing in order to avoid production of a vacuum inside the container with continuous dispensing actions. Otherwise, air must enter from the bottom spout after one, dispensing, liquid squeeze uses up the available air in the closed container. Interrupted dispensing actions allows air to come back up through the single bottom spout in a “hiccup” action with non-viscous liquids and failed operation with viscous liquids causing the user to turn the bottle right-side up which clears viscous liquid out of the bottom-nozzle.

This Febbraro patent will allow use of the dual-use, top opening as an air intake opening even when it is not designed or specified for this purpose while the liquid dispensing occurs on the single-use, bottom nozzle. The drawback of this Febbraro design is that viscous and air hardened, liquid chemical will in all probability clog or partially clog the current top opening blocking or reducing the air intake of a duo-use opening. If the top opening is made large it will reduce such air blockage problems. As specified in the design and legal claims of the Febbraro patent, the top opening is covered by a removable cap. A removable cap is not the best choice for an air nozzle as the cap must be stored somewhere and re-fastened after use.

Unlike the present applicant's invention, this Febbraro patent also does not have a drip catching removable bottom piece, so, liquid drips will fall on a table or floor, also this Febbraro patent describes a recessed bottom with a built-in, stand to cover the bottom-nozzle and bottom-cap.
U.S. Pat. No. 1,660,606
Date of Issue: Feb. 28, 1928
Filing Date: Apr. 19, 1926
Issued to: Evans, Hopkins

This Evans patent covers a house-hold, liquid dispensing, bottle shaped like a glass, milk-bottle, with an open top having a removable cap and a screw-on, sealed bottom without the use of any opening or nozzle. This bottle is intended for top dispensing only. The screw-on, sealed bottom is merely used in factory maintenance at the bottling plant to allow easier either end and through the ends cleaning and scrubbing of used bottles such as re-usable glass milk and glass cola bottles.

This Evans patent does not have a dedicated, top mounted ventilation hole protected by a one-way diaphragm which allows air down, but, does not allow liquid to move up. The present inventor's invention includes such a valve. This dedicated, top mounted ventilation hole is necessary for proper efficient dispensing in order to avoid production of a vacuum inside the container with continuous dispensing actions. Otherwise, air must enter from the bottom spout after one, dispensing, liquid squeeze uses up the available air in the closed container. Interrupted dispensing actions allows air to come back up through the single bottom spout in a “hiccup” action with non-viscous liquids and failed operation with viscous liquids causing the user to turn the bottle right-side up which clears viscous liquid out of the bottom-nozzle.

Unlike the present appplicant's invention, this Evans patent also does not have a drip catching removable bottom piece, as, bottom dispensing is not allowed.
U.S. Pat. No. 315,096
Date of Issue: Mar. 5, 1991
Filing Date: Jan. 12, 1987
Issued to: Rocchio, Chris A.

This Rocchio design patent covers a house-hold, liquid dispensing, bottle with an open top having a removable cap and a sealed bottom with a nozzle and removable cap.

The liquid chemical held inside the bottle shaped, dispenser can flow to either top or bottom nozzle with top dispensing used most of the time and bottom dispensing used when the bottle is low with liquid chemical.

This Rocchio patent does not have a dedicated, top mounted ventilation hole protected by a one-way diaphragm which allows air down, but, does not allow liquid to move up. The present inventor's invention includes such a valve. This dedicated, top mounted ventilation hole is necessary for proper efficient dispensing in order to avoid production of a vacuum inside the container with continuous dispensing actions. Otherwise, air must enter from the bottom spout after one, dispensing, liquid squeeze uses up the available air in the closed container. Interrupted dispensing actions allows air to come back up through the single bottom spout in a “hiccup” action with non-viscous liquids and failed operation with viscous liquids causing the user to turn the bottle right-side up which clears viscous liquid out of the bottom-nozzle.

This Rocchio patent will allow use of the dual-use, top opening as an air intake opening even when it is not designed or specified for this purpose while the liquid dispensing occurs on the single-use, bottom nozzle. The drawback of this Rocchio design is that viscous and air hardened, liquid chemical will in all probability clog or partially clog the current top opening blocking or reducing the air intake of a duo-use nozzle. If the top opening is made large it will reduce such air blockage problems.

Unlike the present applicant's invention, this Rocchio patent also does not have a drip catching removable bottom piece, so, liquid drips will fall on a table or floor, also this Rocchio patent describes a recessed bottom with a built-in, stand to cover the bottom-nozzle and bottom-cap.

Prior Art to the Original Patent Application Filing Date of Injection Molded Plastic Tops From Crown, Cork, and Seal Annual Reports [REF 4][REF 8]:

The pages from these two annual reports give the dated prior art of already existing personal sized, bottom dispensing, bottles and tubes (regardless of the orientation of the printed label with sideways label printing and vertical label printing orientations used in prior art), as well as plastics injection molded ‘plastic fittings’ or ‘plastic closures.’ The basic difference between the ‘prior art’ of various types of ‘plastic fittings’ for personal sized, top dispensing containers shipped with a shrink-wrapped with plastic wrap, card-board box at extra cost and sometimes cardboard box detailed instructions, with an optional paper insert of very detailed instructions slipped into the cardboard box, vs. the present applicant's invention of a personal sized, bottom dispensing, bottle with the desired features of an air tight seal for longer liquid chemical shelf life, water tight seal, anti-insect seal, anti-drip catching, and built-in table stand and bottom cap, was the relatively narrower diameter of the ‘plastic fitting,’ typically being less than 2.0″ in diameter.

Many prior art of plastic injection molding technology ‘plastic fittings’ existed designed for top dispensing bottles and tubes such as:

1). A single piece, female threaded screw-on cap which screw attached to male thread on the exterior rim of a bottle or tube nozzle or narrow throat opening, with an opposing end built-in ‘living hinge’ which supported a snap-on/snap-off cap.

2). A single piece, female threaded screw-on cap which screw attached to male thread on the exterior rim of a bottle or tube nozzle or narrow throat opening, with an opposing end built-in ‘living hinge’ which supported a snap-on/snap-off partial cap with parallel edges.

3). A two piece, female threaded screw-on cap which screw attached to male thread on the exterior rim of a bottle or tube nozzle or narrow throat opening, with an opposing end ‘snap-in’ spout which had swivel-open/swivel-close action to squirt out a liquid as for sports water bottles.

4). A two piece, female threaded screw-on cap which screw attached to male thread on the exterior rim of a bottle or tube nozzle or narrow throat opening, with an opposing end ‘snap-in’ disk valve which had swivel-open/swivel-close action to squirt out a liquid for a ‘disk valve.’

5). A two piece, female threaded screw-on cap which screw attached to male thread on the exterior rim of a bottle or tube nozzle or narrow throat opening, with an opposing end ‘snap-in’ disk closure which had swivel-open/swivel-close action to squirt out a liquid for a ‘disk closure.’

The vast majority of the prior art is with personal sized, top dispensing bottles and tubes. In the few prior art known cases of personal sized, bottom dispensing tubes, these were simply relatively large (about 1.50″ diameter top ‘plastic fitting’), top-dispensing tubes which were used for ‘bottom dispensing’ by simply printing the label on with a bottom dispensing label orientation which made the tubes prone to top-heavy design, easy inadvertently flipping over from top-heaviness, especially with a liquid chemical full fairly un-used tube, and often using a simple screw-on plastic cap. The present inventor has no known prior knowledge of public domain, ‘prior art’ to his USPTO document disclosure date (DDP) of ‘system designed’ personal sized, bottom dispensing, soft squeezable, either tubes or bottles, beyond the relevant stated IDD USPTO patents.

Post Art to the Original Patent Application Filing Date, but, Prior Art to the CIP Patent Filing Date, of a Heinz (R) Brand of “Easy Squeeze (R)” Personal Sized, Bottom Dispensing Bottle for ketchup [REF 20]:

This post-art documents to the original patent filing date, but, prior art to the CIP patent filing date, the dated development of the Heinz Easy Squeeze (R) ketchup bottle from a Heinz Web site print-out. The present applicant's USPTO Document Disclosure Program (DDP) invention date far preceded this dated material.

Post Art to the Original Patent Application Filing Date, but, Prior Art to the CIP Patent Filing Date of a Crown, Cork, and Seal (R) Corporation, 100% Owned Division, Crown-Zeller (r) Packaging Division, Web Site Print-Out for Plastics Injection Molding Technology [REF 24:

This post-art documents the dated development of the modifications in plastic injection molding technology for personal sized, bottom dispensing bottles vs. the older, personal sized, top dispensing bottles. The major impact on plastics injection molding was to offer much larger diameter ‘plastic fittings’ or ‘plastic closures’ with standard female threaded, screw-on bases which screw attached to a male thread on the outside rim or nozzle or narrow throat opening of a bottle or tube. The minimum diameter of a personal sized, bottom dispensing, ‘plastic fitting’ or ‘plastic closure’ exceeded 2.0″, where a maximum diameter ‘plastic fitting’ or ‘plastic closure’ limit occurred for too much plastic resin material cost.

The present applicant's USPTO Document Disclosure Program (DDP) invention date far preceded this dated material.

### BRIEF SUMMARY OF THE INVENTION

A personal size, bottle device (100) for dispensing liquid chemicals (204) with means for dispensing of the liquid chemicals (204) utilizing gravity-fed operation through the dedicated to liquid and not air (200) real bottle bottom with nozzle (108) with a dedicated to air and not liquid, twist ventilation only cap (102), real bottle top with ventilation hole (104) used for air (200) intake through a one-way trap door diaphragm (103).

Objects & Advantages—Over Prior Art

A. An object of this invention is to prevent the nagging wait for a prior art bottle turned upside-down to drain especially from a low bottle with thick liquid chemicals (204).

B. An object of this invention is to prevent the dispensing of air (200) and bon-emulsified liquid from liquid chemical (202) which floats to the top of a prior art bottle.

C. An object of this invention is to stop the waste of liquid chemical (204) at the bottom of prior art bottles which is now often thrown away.

D. An object of this invention is to stop the waste of liquid chemical (204) at the sides of prior art bottles which clings there after the bottle is turned upside down and increases in amount when the bottle is near empty.

E. An object of this invention is to not require the need to flip the bottle (100) upside down to dispense liquid chemical (204) such as in motor oil which creates messy spills when the target is missed and wastes effort.

F. An object of this invention is to be inexpensive and convenient to use in comparison to prior art bottles.

G. An object of this invention is that it can be made with current manufacturing technologies for glass and plastic.

H. An object of this invention is that it uses a dedicated twist ventilation only cap (102), and real bottle top with ventilation hole (104) for air (200) ventilation and a dedicated, real bottle bottom with nozzle (108) for bottom only dispensing of the liquid chemical (204).

I. An object of this invention is that it uses a special one-way trap door diaphragm (103) type of diaphragm at the top of the bottle (100) to stop accidental liquid chemical (204) spills from the real bottle top with ventilation hole (104) and twist ventilation only cap (102).

J. An object of the 1^{st} embodiment of this invention is to accommodate low viscosity liquid chemicals such as shampoos with lowest cost by elimination of un-necessary parts.

K. An object of the 2^{nd} embodiment of this invention is to accommodate very low viscosity liquid chemicals such as rinse with lowest cost by elimination of un-necessary parts.

L. An object of the 3^{rd} embodiment of this invention is to accommodate low viscosity liquid chemicals such as rinse with lowest cost by elimination of un-necessary parts.

Z. Further objects and advantages of my invention will become apparent from a consideration of the drawings and ensuing description of it.

### BRIEF DESCRIPTION OF THE SEVERAL VIEWS OF THE DRAWINGS—All EMBODIMENTS

FIG. 1 is a perspective drawing of the invention, a gravity-fed liquid chemical dispenser bottle (100), as it would appear standing on a kitchen table (208).

FIG. 2 is a close-up view of the actions of optionally twisting the twist ventilation only cap (102), and removing the false bottle bottom or stand (112) to expose the real bottle bottom with nozzle or narrow throat opening (108). The flip-off/flip-on nozzle cap or plastic fitting (110), on real nozzle bottom with nozzle or narrow throat opening (108) is shown in a closed position.

FIG. 3 is a close-up view of the action of dispensing liquid chemical (204) through the real bottle bottom with nozzle or narrow throat opening (108), after removal of the false bottle bottom or stand (112) and opening the flip-off/flip-on nozzle cap or plastic fitting (110), on real nozzle bottom with nozzle or narrow throat opening (108). A hamburger (206) is shown to receive the liquid chemical (204) which in this case is ketchup.

FIG. 4 is a close-up view of the action of closing the flip-off/flip-on nozzle cap or plastic fitting (110), on real bottle bottom with nozzle or narrow throat opening (108), and placing the liquid chemical bottle body (106) back upon the false bottle bottom or stand (112). The twist ventilation only cap (102) is lastly twisted shut.

FIG. 5 is a close-up view of the action of manufacturing assembly of the twist ventilation only cap (102) to the liquid chemical bottle body (106), the bottom open container is assumed placed up-side down in an assembly line liquid chemical (204) filling factory operation, the liquid chemical (204) is injected into the bottle, the real bottle bottom with nozzle or narrow throat opening (108) is right hand rule or clockwise screwed on, the flip-off/flip-on nozzle cap or plastic fitting (110) is right hand rule or clockwise screwed on, the false bottle bottom or stand (112) is snapped on.

FIG. 6 is a close-up view of the action of manufacturing assembly of a low viscosity 1^{st} embodiment with removal of some rendered un-necessary parts, showing, the liquid chemical bottle body (106), the bottom open container is assumed placed up-side down in an assembly line liquid chemical (204) filling factory operation, the liquid chemical (204) example shampoo, is injected into the bottle, the real bottle bottom with nozzle or narrow throat opening (108) is right hand rule or clockwise screwed on, the false bottle bottom or stand (112) is snapped on.

FIG. 7 is a close-up view of the action of manufacturing assembly of a very low viscosity 2^{nd} embodiment with removal of some rendered un-necessary parts, showing, the liquid chemical bottle body (106), the bottom open container is assumed placed up-side down in an assembly line liquid chemical (204) filling factory operation, the liquid chemical (204) example rinse, is injected into the bottle, the real bottle bottom with nozzle or narrow throat opening (108) is right hand rule or clockwise screwed on, the flip-on/flip-off nozzle cap or plastic fitting (110) is right hand rule or clockwise screwed on, lastly, the false bottle bottom or stand (112) is snapped on.

FIG. 8 is a close-up view of the action of manufacturing assembly of a very low viscosity 3^{rd} embodiment with removal of some rendered un-necessary parts, showing, the liquid chemical bottle body (106), the bottom open container is assumed placed up-side down in an assembly line liquid chemical (204), filling factory operation, the liquid chemical (204) example rinse, is injected into the bottle, the slit diaphragm or plastic fitting (144) is inserted into the internals of the nozzle of the real bottle bottom with nozzle (108), the real bottle bottom with nozzle or narrow throat opening (108) is right hand rule or clockwise screwed on, lastly, the false bottle bottom or stand (112) is snapped on.

### LIST OF REFERENCE NUMERALS—ALL EMBODIMENTS

100. gravity-fed liquid chemical dispenser bottle
102. twist ventilation only cap
103. one-way trap door diaphragm
104. real bottle top with ventilation hole
106. liquid chemical bottle body
108. real bottle bottom with nozzle or narrow throat opening
110. flip-off/flip-on nozzle cap or plastic fitting
112. false bottle bottom or stand
140. well formation
142. connecting flap
144. slit diaphragm

### Following Parts are Not Part of Invention

200. air
202. non-emulsified liquid from liquid chemical
204. liquid chemical
206. hamburger
208. kitchen table

### DETAILED DESCRIPTION OF THE INVENTION—Detailed Description of Drawings—Preferred Embodiment

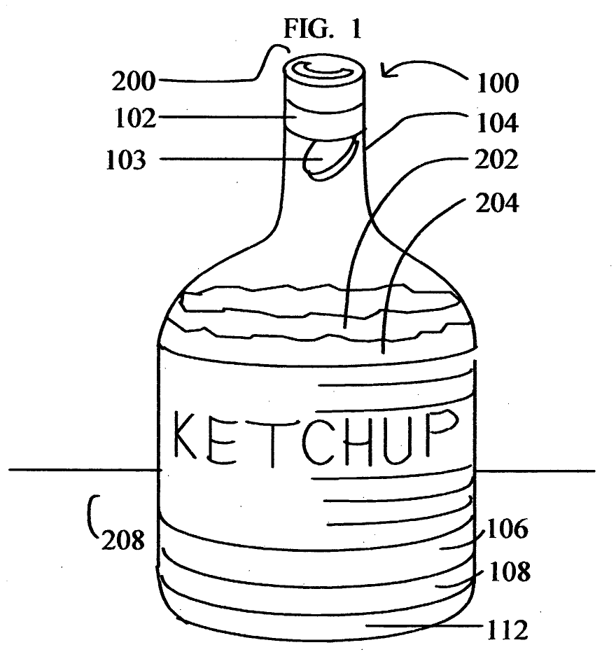

FIG. 1 is a perspective drawing of the invention, a gravity-fed liquid chemical dispenser bottle (100), as it would appear standing on a kitchen table (208).

The twist ventilation only cap (102) is shown, the one-way trap door diaphragm (103) is shown, the real bottle top with ventilation hole (104) is shown, the liquid chemical bottle body (106) is shown, the real bottle bottom with nozzle (108) is shown, and the false bottle bottom or stand (112) is shown. The non-emulsified liquid from liquid chemical (202) is shown settling to the top of the liquid chemical (204). The liquid chemical (204) is shown. The gravity-fed liquid chemical dispenser bottle (100) may be optionally shaken before use.

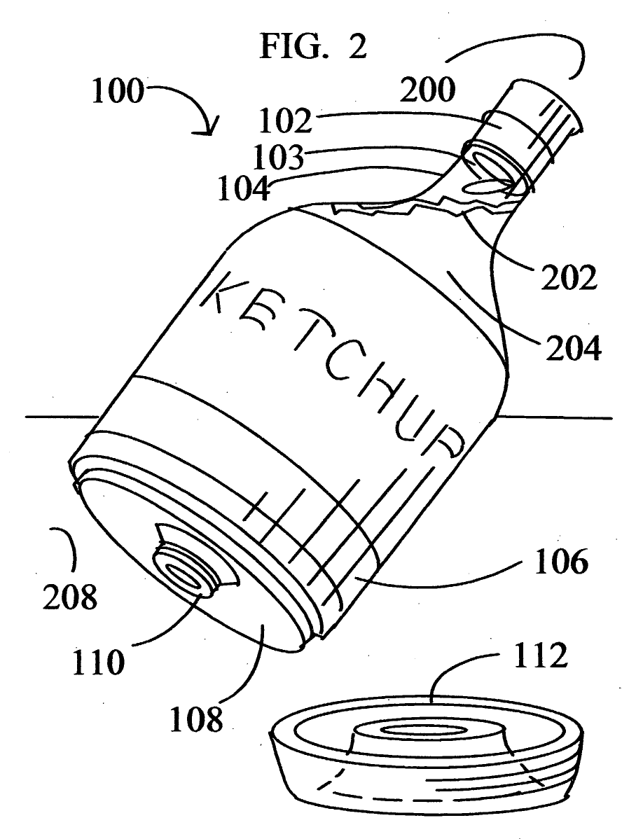

FIG. 2 is a close-up view of the actions of optionally twisting the twist ventilation only cap (102), and removing the false bottle bottom or stand (112) to expose the real bottle bottom with nozzle (108). The flip-off/flip-on nozzle cap (110) on real nozzle bottom with nozzle (108) is shown in a closed position.

The actions of twisting the twist ventilation only cap (102) to prevent a vacuum on large dispenses is shown. The one-way trap door diaphragm (103) is shown below the twist ventilation only cap (102) with the intended action of allowing air (200) intake in a downwards motion and preventing liquid dispensing from the twist ventilation only cap (102) and real bottle top with ventilation hole (104) which prevents the unwanted effect of dried liquid chemical (204) blocking or partially blocking the dedicated top nozzle. The flip-off/flip-on nozzle cap (110) on real bottle bottom with nozzle (108) is shown in a closed position. The real bottle top with ventilation hole (104) and the real liquid chemical bottle body (106) are shown. The action of removing the false bottle bottom or stand (112) to expose the real bottle bottom with nozzle (108) is shown. The flip-off/flip-on nozzle cap (110) on real nozzle bottom with nozzle (108) is shown in a closed position.

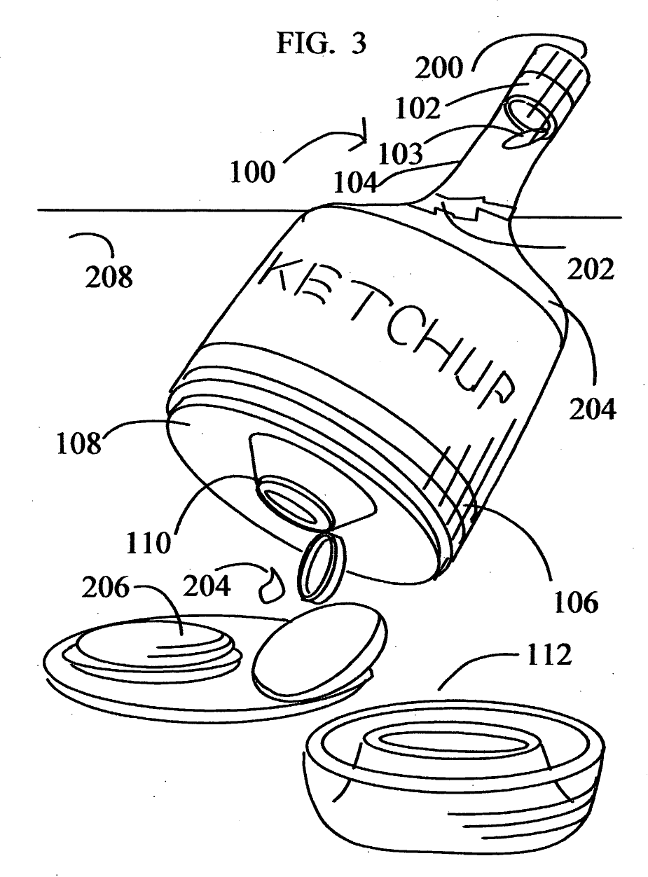

FIG. 3 is a close-up view of the action of dispensing liquid chemical (204) through the real bottle bottom with nozzle (108) after removal of the false bottle bottom or stand (112) and opening the flip-off/flip-on nozzle cap (110) on real nozzle bottom with nozzle (108). A hamburger (206) is shown to receive the liquid chemical (204) which in this case is ketchup.

The twist ventilation only cap (102) is shown already twisted open, the real bottle top with ventilation hole (104) is shown letting in air (200), the liquid chemical bottle body (106) is shown. The non-emulsified liquid from liquid chemical (202) is shown settling to the top of the liquid chemical (204). The liquid chemical (204) is shown.

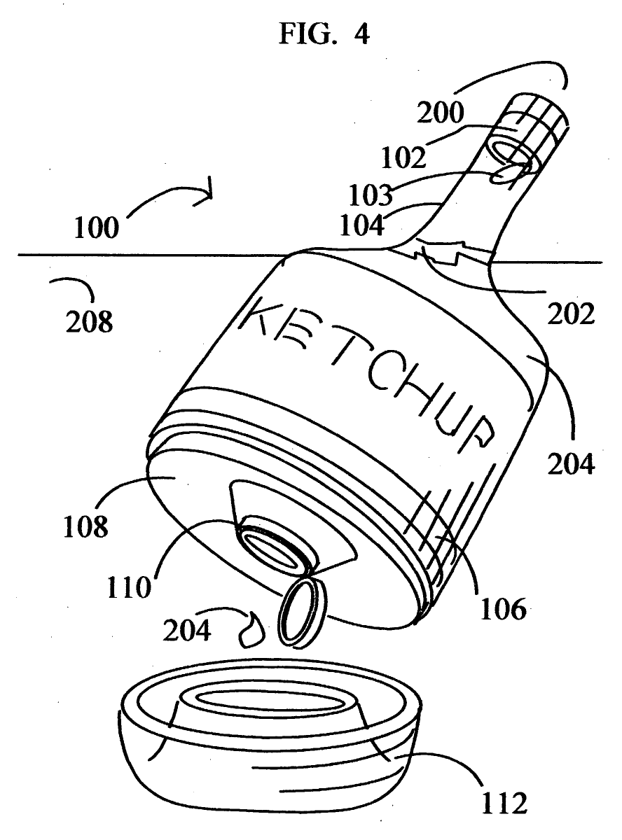

FIG. 4 is a close-up view of the action of closing the flip-off/flip-on nozzle cap (110) on real bottle bottom with nozzle (108), and placing the liquid chemical bottle body (106) back upon the false bottle bottom or stand (112). The twist ventilation only cap (102) is lastly twisted shut.

The real bottle top with ventilation hole (104) is shown. The non-emulsified liquid from liquid chemical (202) is shown settling to the top of the liquid chemical (204).

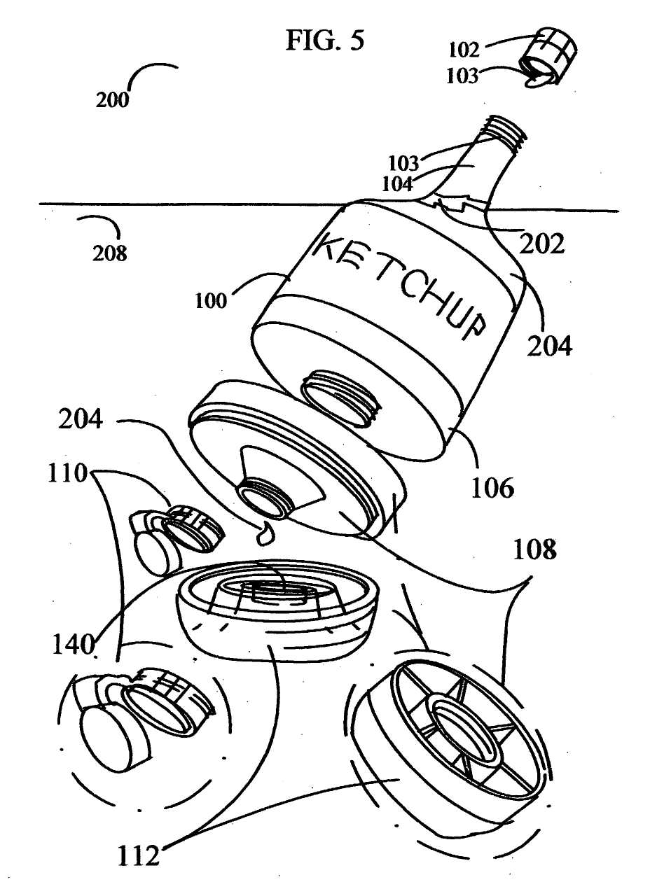

FIG. 5 is a close-up view of the action of manufacturing assembly of the twist ventilation only cap (102) to the liquid chemical bottle body (106), the bottom open container is assumed placed up-side down in an assembly line liquid chemical (204) filling factory operation, the liquid chemical (204) is injected into the bottle, the real bottle bottom with nozzle or narrow throat opening (108) is right hand rule or clockwise screwed on, the flip-off/flip-on nozzle cap or plastic fitting (110) is right hand rule or clockwise screwed on, the false bottle bottom or stand (112) is snapped on.

### Advantages of the Invention—Preferred Embodiment—How the Objects are Achieved

A. An advantage of this invention is that it prevents the nagging wait for a prior art bottle turned upside-down to drain especially from a low bottle with thick condiments/pharmaceuticals.

This is due to the gravity-fed operation and bottom dispensing in the said invention.

B. An advantage of this invention is that it prevents the dispensing of air (200) and non-emulsified liquid from liquid chemical (202) which floats to the top of a prior art bottle.

This is due to the air (200) and non-emulsified liquid from liquid chemical (202) remaining on top while the dispensing is from the bottom in the said invention.

C. An advantage of this invention is that it stops the waste of liquid chemical (204) at the bottom of prior art bottles which is now often thrown away.

This is due to dispensing from the bottom in the said invention. Furthermore, prior art bottles required tipping the container over which deposited liquid chemical (204) from the previous bottom upon the gravity drained sides of the container.

D. An advantage of this invention is that it stops the waste of liquid chemical (204) at the sides of prior art bottles which clings there after the bottle is turned upside down and increases in side cling amount when the prior art bottle is near empty.

This is prevented by dispensing from the bottom of the said invention. Furthermore, prior art bottles required tipping the container over which deposited liquid chemical (204) from the previous bottom upon the gravity drained sides of the container.

E. An advantage of this invention is that it does not require the need to flip the prior art bottle upside down to dispense liquid chemical (204) such as in motor oil which creates messy spills and wastes effort when the target is missed.

This is prevented in the said invention by dispensing from the real bottle bottom with nozzle (108).

F. An advantage of this invention is that it is inexpensive and convenient to use in comparison to prior art bottles.

This is due to simple design and use of low cost materials in the said invention just as in prior art bottles.

G. An advantage of this invention is that it can be made with current manufacturing technologies for glass and plastic.

This is due to simple design in the said invention just as in prior art bottles.

H. An advantage of this invention is that it uses a dedicated twist ventilation only cap (102), real bottle top with ventilation hole (104) for air (200) ventilation and a dedicated to liquid, real bottle bottom with nozzle (108) for bottom only dispensing of the liquid chemical (204).

This allows “smooth and continuous” operation without “hiccupping actions” from a single nozzle for air (200) and liquid. This also prevents dried liquid chemical (204) from blocking or partially blocking the top twist ventilation only cap (102), one-way trap door diaphragm (103), and real bottle top with ventilation hole (104) if it is also used for liquid chemical (204) dispensing.

I. An advantage of this invention is that it uses a special one-way trap door diaphragm (103) type of diaphragm at the top of the bottle to stop accidental liquid chemical (204) spills from the real bottle top with ventilation hole (104) and twist ventilation only cap (102) and also to stop liquid chemical (204) dispensing from the top which will clog the air ventilation openings after drying.

This insures that the twist ventilation only cap (102) and real bottle top with ventilation hole (104) is used only for air intake and not liquid chemical (204) dispensing preventing “gum up” and also accidental spills from the top if the bottle is flipped upside-down by mistake.

1^{st} Alternative Embodiment Detailed Drawing Figures, Operation, and Advantages

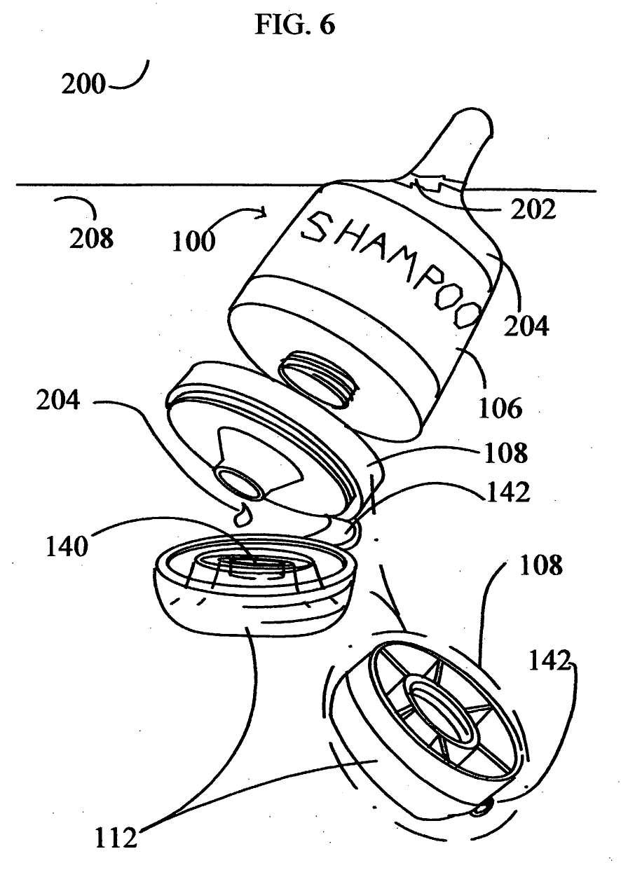

FIG. 6 is a close-up view of the action of manufacturing assembly of a low viscosity 1^{st} embodiment with removal of some rendered un-necessary parts, showing, the liquid chemical bottle body (106), the bottom open container is assumed placed up-side down in an assembly line liquid chemical (204) filling factory operation, the liquid chemical (204) example shampoo, is injected into the bottle, the real bottle bottom with nozzle or narrow throat opening (108) is right hand rule or clockwise screwed on, the false bottle bottom or stand (112) is snapped on.

J. An advantage of the 1^{st} embodiment of this invention is to accommodate low viscosity liquid chemicals such as shampoos with lowest cost by elimination of un-necessary parts.

2^{nd} Alternative Embodiment Detailed Drawing Figures, Operation, and Advantages

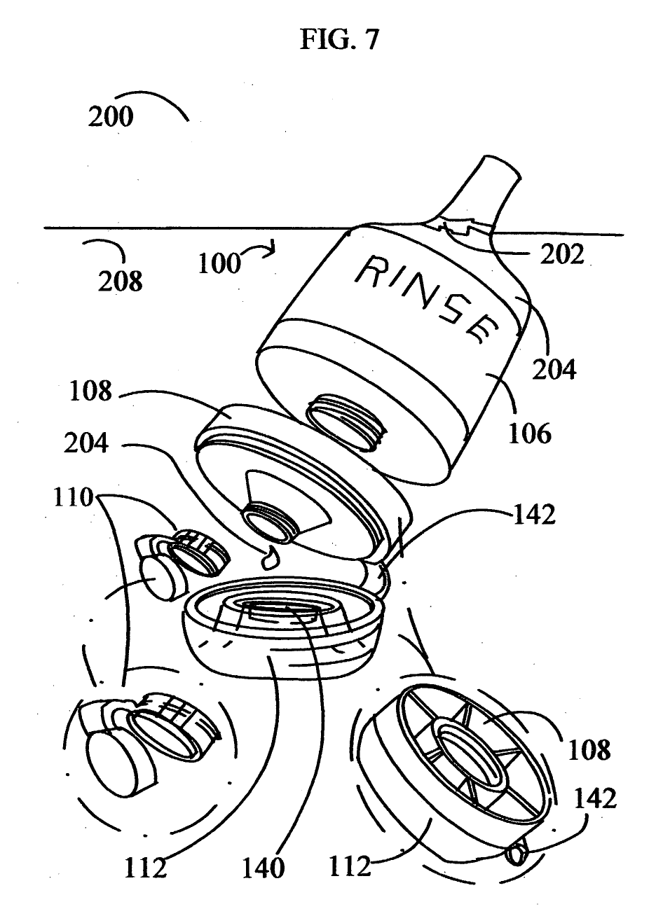

FIG. 7 is a close-up view of the action of manufacturing assembly of a very low viscosity 2^{nd} embodiment with removal of some rendered un-necessary parts, showing, the liquid chemical bottle body (106), the bottom open container is assumed placed up-side down in an assembly line liquid chemical (204) filling factory operation, the liquid chemical (204) example rinse, is injected into the bottle, the real bottle bottom with nozzle or narrow throat opening (108) is right hand rule or clockwise screwed on, the flip-on/flip-off nozzle cap or plastic fitting (110) is right hand rule or clockwise screwed on, lastly, the false bottle bottom or stand (112) is snapped on. Some added parts shown are a well formation (140) to catch loose liquid chemical (204) drips, a connecting flap (142) to connect the real bottle bottom with nozzle or narrow throat opening (108) to the false bottle bottom or stand (112), and a slit diaphragm (144) to act as functional replacement for the flip-up/flip-down nozzle cap or plastic fitting.

K. An advantage of the 2^{nd} embodiment of this invention is to accommodate very low viscosity liquid chemicals such as rinse with lowest cost by elimination of un-necessary parts.

₃rd Alternative Embodiment Detailed Drawing Figures, Operation, and Advantages

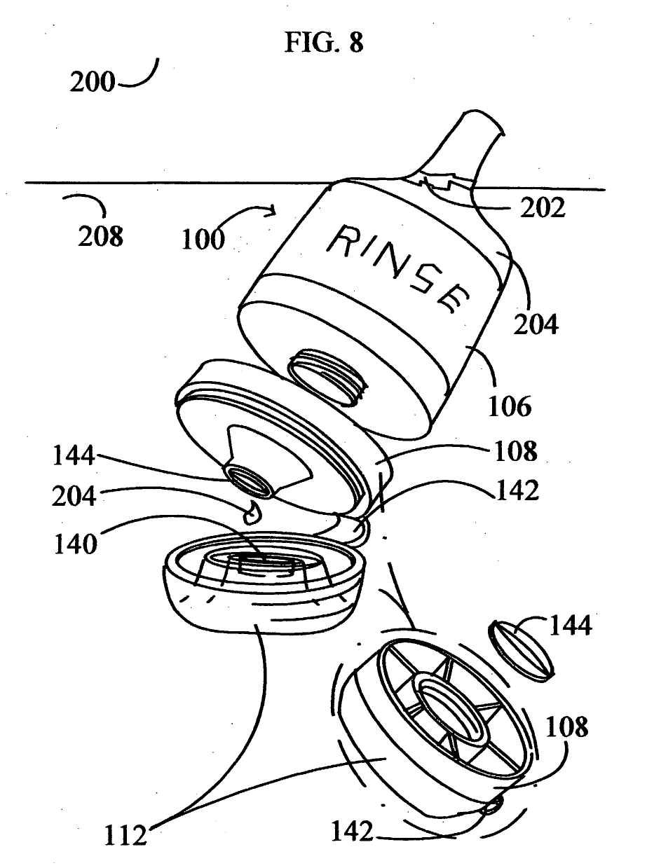

FIG. 8 is a close-up view of the action of manufacturing assembly of a very low viscosity 3^{rd} embodiment with removal of some rendered un-necessary parts, showing, the liquid chemical bottle body (106), the bottom open container is assumed placed up-side down in an assembly line liquid chemical (204) filling factory operation, the liquid chemical (204) example rinse, is injected into the bottle, the slit diaphragm or plastic fitting (144) is inserted into the internals of the nozzle of the real bottle bottom with nozzle (108), the real bottle bottom with nozzle or narrow throat opening (108) is right hand rule or clockwise screwed on, lastly, the false bottle bottom or stand (112) is snapped on. Some added parts shown are a well formation (140) to catch loose liquid chemical (204) drips, a connecting flap (142) to connect the real bottle bottom with nozzle or narrow throat opening (108) to the false bottle bottom or stand (112), and a slit diaphragm (144) to act as functional replacement for the flip-up/flip-down nozzle cap or plastic fitting.

L. An advantage of the 3^{rd} embodiment of this invention is to accommodate low viscosity liquid chemicals such as rinse with lowest cost by elimination of unnecessary parts.

Conclusion and Scope of Invention

A. This invention prevents the nagging wait for a prior art bottle turned upside-down to drain especially from the bottom of the bottle.

B. This invention prevents the dispensing of air (200) and non-emulsified liquid from liquid chemical (202) which floats to the top of a prior art bottle.

C. This invention stops the waste of liquid chemical (204) at the bottom of prior art bottles which is now often thrown away.

D. This invention stops the waste of liquid chemical (204) at the sides of prior art bottles which clings there after the bottle is turned upside down and increases in amount when the bottle (100) is near empty.

E. This invention stops the need to flip the bottle (100) upside-down as for ketchup or motor oil which can result in messy spills when the target is missed.

F. This invention is inexpensive and convenient to use in comparison to prior art bottles.

G. This invention can be made with current manufacturing technologies for glass and plastic just like prior art bottles.

H. This invention uses a dedicated, twist ventilation only cap (102), and real bottle top with ventilation hole (104) for air (200) ventilation and a dedicated, real bottle bottom with nozzle (108) for bottom only dispensing of the liquid chemical (204). This effect is achieved by the one-way trap door diaphragm (103) which prevents liquid chemical (204) dispensing from the top nozzle.

I. This invention uses a special one-way trap door diaphragm (103) at the top of the bottle (100) to stop accidental liquid chemical (204) spills from the real bottle top with ventilation hole (104) and twist ventilation only cap (102) and also to stop liquid chemical (204) dispensing from the top which will clog the air ventilation openings after drying.

J. This invention in its 1^{st} embodiment accommodates low viscosity liquid chemicals such as shampoos with lowest cost by elimination of un-necessary parts.

K. This invention in its 2^{nd} embodiment accommodates very low viscosity liquid chemicals such as rinse with lowest cost by elimination of un-necessary parts.

L. This invention in its 3^{rd} embodiment accommodates low viscosity liquid chemicals such as rinse with lowest cost by elimination of un-necessary parts.

While my above description contains many specifications, these should not be construed as limitations on the legal claims of the invention, but rather as an example of one preferred embodiment thereof. Many other variations or secondary and alternative preferred embodiments are possible. For example a fully or partially removable false twist ventilation only cap (102) or fully attached twist ventilation only cap (102) can be optionally used. The bottle body (106) may be of any material including squeezable plastic, hard plastic, glass (will require a shaking motion, larger ventilation opening (104), and a larger dispensing nozzle), etc. The bottle (100) may be of any shape avoiding top-heavy design. The flip-off/flip-on nozzle cap 110) may be twist open and close, or flip open and close, or spray with a push-cap and feed The false bottle bottom or stand (112) can be screw-on for spill safety, flip-on, or snap on for convenience or a combination of both. The false bottle bottom or stand (112) can be fully or partially detachable. Accordingly, the scope of the invention should be determined not by the embodiment(s) illustrated, but by the appended claims and their legal equivalents.

1. A personal sized device for convenient and human highly: controlled dispensing of high viscosity, liquid chemicals comprising:
a liquid chemical bottle body with a first end identified as the lowest accumulated gravitational force end when in normal dispending use position, furthermore, whose second open end is non-integral structurally with a real bottle bottom with nozzle, furthermore, the first end of said liquid chemical bottle body has no structural attachment and detachment mechanisms for a false bottle bottom or stand as in some surveyed prior art, furthermore, said liquid chemical bottle body has no structural positional lugs or automatic bottling equipment orientation deformation usually used with perfectly cylindrical bottles when labels and direct printing must be applied which must miss the distorting of lettering, side seams,
a real bottle bottom with nozzle or narrow throat opening, furthermore, whose first end is identified as the end which mechanically attaches to the second end of said liquid chemical bottle body, furthermore, said real bottle bottom with nozzle is structurally non-integral with said liquid chemical bottle body with built-in second end opening, furthermore, the second end of said real bottle bottom with nozzle, has a structural means of a nozzle or narrow throat opening or very carefully controlled diameter nozzle for functional means on the human held, squeeze-in stroke, of a very carefully pre-designed, human aiming and squirting action of said liquid chemical, furthermore, the human held, manual, squeeze-out stroke of desired air to counter a vacuum inside said liquid chemical bottle body of in taking into said liquid chemical bottle body an anti-vacuum fresh air in-flow,
a nozzle cap or plastic fitting, with a first end of said nozzle cap identified as the end nearest said real bottle bottom with nozzle, furthermore, with structural means for flip-on and flip-off nozzle cap human action, with corresponding functional means for desired dispensing said liquid chemical only upon a human squeeze-in stroke action while the said nozzle cap or plastic fitting is in an open dispensing position, furthermore, followed in sequence by the following anti-vacuum, human squeeze-out stroke action also while said nozzle cap or plastic fitting is in an open dispensing position, furthermore, a final sequence, closed dispensing position nozzle cap or plastic fitting for hermetic and sanitary storage of said liquid chemical for intended storage, furthermore, said nozzle cap through the structural means of said flip-on and flip-off nozzle cap has functional means for avoiding unwanted said liquid chemical drips in said intended storage use,
a false bottle bottom or stand with a first end identified as the end nearest said nozzle cap, furthermore, with structural means on its first end of a first end open, cup like opening with functional means for serving as a drip catching cup, furthermore, with structural means on its second end of a flat surface with functional means for serving as a table stand, furthermore, with first end of said a false bottle bottom or stand structural means of a snap-on and snap-off attachment with functional means to attach to the proximate second end of said real bottle bottom with nozzle,
whereby the invention elements taken as a whole are new art systematically meeting of non-top heavy design either by relatively shortening of invention over-all height, relatively widening of over-all invention width, relatively lowering of over-all center of mass, or relatively making shapes and chosen materials, non-top heavy in over-all weighting versus simply taking prior art, older top dispensing and side dispensing packaging designs and printing labels at a 90 degree angle for bottom dispensing uses,
whereby there is accomplished means for desired, human control in direction and volume dispensing of said liquid chemical, dispensing of said liquid chemical utilizing gravity-fed operation assisted by human squeeze-in actions with highly controlled, liquid chemical dispensing done only through careful tolerances openings of said nozzle or narrow throat opening on said real bottle bottom with nozzle,
whereby there is accomplished means for no unwanted dispensing of the non-emulsified liquid which in the normal storage position tends to accumulate with lower density of said non-emulsified liquids causing a floating up to the least gravity action, to said liquid chemical bottle body's normal top or first end, being limited in dispensing actions to said liquid chemical's very low, remaining volume stages,
whereby there is accomplished means for convenient top of table storage in the storage position,
whereby there is accomplished means for desired, human controlled storage of said liquid chemical in a sanitary storage container which is, hermetically sealed during storage for 100% oxidation prevention of said liquid chemical to preserve shelf-life, furthermore, an internal to said entire invention, said liquid chemical is 100% storage sealed for unwanted drips, furthermore, external chlorinated tap water used to wash off said invention is 100% sealed from said liquid chemical, furthermore, external dirt and dust carrying air borne bacteria in bathrooms is 100% sealed from said liquid chemical, furthermore, crawling and flying insects are 100% sealed from said liquid chemical.

2. The invention of claim 1 further including that said liquid chemical bottle body has a first end, additional, integral real bottle top with opening, furthermore, said real bottle top with opening has structural means to intake fresh atmospheric air to said liquid chemical bottle body with functional means of aiding very viscous liquid chemical use as but not restricted to white glues.

3. The invention of claim 1 further including that said liquid chemical bottle body has a first end mechanically attached, a one-way diaphragm structural mechanism which has functional means to prevent liquid chemical from going towards the first end of said liquid chemical bottle body during a human squeeze-in stroke where it may harden in storage and jam up said one-way diaphragm, furthermore, functional means to prevent air from going towards the first end of said liquid chemical bottle body during a human squeeze-in stroke directing all air pressure to thrust said liquid chemical out said real bottle bottom with nozzle or narrow throat opening, furthermore, said one-way diaphragm structure has structural means to accomplish functional means of allowing air to penetrate towards the first end of said liquid chemical bottle body only during the human squeeze-out stroke.

4. The invention of claim 1 further including that said liquid chemical bottle body has a first end, additional, mechanically attached, a twist open ventilation cap, furthermore, said twist open ventilation cap has mechanical structural means to twist-open and twist-close said twist open ventilation cap, in some human highly controlled in time and air volume, adjustable manner, with functional means to expose fresh atmospheric air to said real bottle top with ventilation hole or air opening, furthermore, with functional means for preventing said liquid chemical bottle body from developing a semi-permanent vacuum at the end of the human squeeze-in action dispensing of large quantities of very viscous liquid chemical where the inwards force of liquid viscosity and partial vacuum, exceeds the outwards restorative force of flexible container natural shape restoration, furthermore, said human controlled and human selected air intake may be entirely human selected only during the end of the human squeeze-in action when maximum air intake is desired on the human squeeze-out action to relieve said liquid chemical bottle body partial vacuum resulting only from very viscous liquid chemicals such as but not restricted to white house-hold glue.

5. The invention of claim 4 further including that the second end of said twist ventilation open cap, as in the prior art of industry standard, plastic fittings or plastic closures, structurally attaches through a female screw thread juncture on the internal sides of said twist ventilation only cap to a male screw thread on the external sides, first end of said real bottle top with ventilation hole integral to said real bottle body, with functional means of mechanical attachment.

6. The invention of claim 1 further including that said liquid chemical bottle body has on its first end, a real bottle top with ventilation hole, which is integral structurally to said liquid chemical bottle body with built-in second end opening, has structural means working in conjunction with human opening actions of said false cap, furthermore, working in conjunction with human squeeze-in action and subsequent human squeeze-out action, with functional means for stopping a semi-permanent vacuum in said liquid chemical bottle body which arises from very viscous liquid chemical inward forces of liquid viscosity combined with air vacuum, being greater than the outwards forces of human squeeze-out action combined with said liquid chemical bottle body structural elasticity or restorative structural shape force outwards force action.

7. The invention of claim 6 further including that said real bottle top with ventilation hole is structurally an integral structural part of said liquid chemical bottle body with second end built-in opening, with functional means of second end air intake for highly viscous said liquid chemical, as opposed to the structural element of the human reversibly openable, said false cap.

8. The invention of claim 1 further including that said liquid chemical bottle body has a desired second end opening diameter, furthermore, said desired opening diameter in said liquid chemical bottle body's second end channels said liquid chemical between said liquid chemical bottle body and said real bottle bottom with nozzle or narrow throat opening, furthermore, said liquid chemical bottle body is structurally of a non-top heavy shape to prevent tipping over of the bottle with functional means of both a relatively lower said over-all invention height over prior art, personal sized, top dispensing bottles, furthermore, a relatively wider said over-all invention width regardless of horizontal shape when compared to the prior art, of personal sized, top dispensing bottles

9. The invention of claim 1 further including that the real bottle bottom with nozzle or narrow throat opening, attaches to the second end, of said liquid chemical bottle using mechanical attachment structural means, furthermore, said real bottle bottom with nozzle is a non-integral structural part of said liquid chemical bottle body which mechanically attaches with prior art mechanical junctures onto said liquid chemical bottle body's second end, furthermore, said real bottle bottom with nozzle uses finely controlled manufacturing processes using plastics injection molding very high tolerance, with functional means for design time, controlling the squirt action for a specific viscosity and also type of said liquid chemical.

10. The invention of claim 1 further including that said real bottle bottom with nozzle or narrow throat opening, has on its second end, a mechanically attached separate non-integral structure of said nozzle cap or plastic fitting, which has a structurally both human openable and human closable mechanical mechanism such as a flip-off and flip-on valve, furthermore, with functional means to dispense said liquid chemical in said liquid chemical bottle body human squeezed position through said nozzle to said nozzle cap open squirting out said liquid chemical, furthermore, with functional means to hermetically or air-tight store said liquid chemical in said liquid chemical bottle body human un-squeezed position through said nozzle to said nozzle cap closed, furthermore, also squirting through said real bottle body with nozzle or narrow throat opening of carefully pre-engineering designed, desired diameter, with functional means of a controlled direction and controlled squirt amount manner, through human controlled squirting action using human squeeze-in and squeeze-out human action coupled with human aiming action.

11. The invention of claim 10 further including that said nozzle cap or plastic fitting, may be a prior art, plastics injection molded plastic fitting or plastic closure flip-off and flip-on nozzle cap, furthermore, which is attached on its first end to the second end of said real bottle bottom with nozzle through structural means of a prior art, male screw thread on the rim of said nozzle and a prior art, female screw-on thread on the insides of said nozzle cap, furthermore, with functional means of relatively semi-permanent attachment of the two structural pieces.

12. The invention of claim 1 further including that said false bottle bottom or stand also has a structural, first end open, cup like, inside geometry with functional means to catch liquid chemical drips, furthermore, said second end of said false bottle bottom or stand is roughly flat in surface with functional means to allow use as a table stand, furthermore, said false bottle bottom or stand is a prior art, simply wider than industry standard, structural plastic fitting or plastic closure of numerous prior art designs with functional means of very inexpensive plastic fitting, very close tolerance manufacture.

13. The invention of claim 12 further including that said false bottle bottom or stand attaches onto said real bottle bottom with nozzle or narrow throat opening, and is fully human reversibly detachable in some structural mechanical manner of a wider than prior art, industry standard, plastic fitting or plastic closure, for functional means of dispensing action, furthermore, full re-attachment of said false bottle bottom or stand has functional means for: a hermetically sealed storage position for non-oxidation preservation of the liquid chemical, liquid chemical drip sealed for stain prevention, tap water rinse sealed for sanitary purposes of washing off dust and dirt, also for crawling and flying insect infestation prevention.
[NOTE: Independent claim and all dependent claim, refers exclusively to original patent application (USPTO application Ser. No. 09/837,314, Dated Apr. 19, 2001) and its original drawings FIGS. 1-4, plus taking advantage of newly discovered, prior art technical material on plastics injection molding plastic fittings, which is dated prior to Apr. 19, 2001 and is submitted with the CIP patent application Information Disclosure Statement (IDS).]

14. A personal sized device for convenient and human highly controlled dispensing of relatively high viscosity, liquid chemicals comprising:
a liquid chemical bottle body with a first end identified as the lowest accumulated gravitational force end when in normal dispending use position, furthermore, whose second open end is non-integral structurally with a real bottle bottom with nozzle, furthermore, the first end of said liquid chemical bottle body has no need for structural attachment and detachment mechanisms for a false bottle bottom or stand as in some surveyed prior art, furthermore, said liquid chemical bottle body has no need for positional lugs which are commonly used for automatic bottling machine orientation in perfectly cylindrical bottles when labels and directly printed inks must be applied missing a cylindrical bottle's side seam,
a real bottle bottom with nozzle or narrow throat opening, furthermore, whose first end is identified as the end which mechanically attaches to the second end of said liquid chemical bottle body, furthermore, said real bottle bottom with nozzle is structurally non-integral with said liquid chemical bottle body with built-in second end opening, furthermore, the second end of said real bottle bottom with nozzle, has a structural means of a nozzle or narrow throat opening or very carefully controlled diameter nozzle for functional means of a manual human held squeeze-in stroke of desired and human aimed dispensing of said liquid chemical through a human squirting action and a squeeze-out stroke of anti-vacuum fresh air in-flow,
a nozzle cap or plastic fitting with a first end of said nozzle cap identified as the end nearest said real bottle bottom with nozzle, furthermore, with structural means for flip-on and flip-off nozzle cap human action, with corresponding functional means for dispensing only upon a human squeeze-in stroke action while said nozzle cap or plastic fitting is in an open position, furthermore, followed in sequence by the following anti-vacuum, human squeeze-out stroke action also while said nozzle cap or plastic fitting is in an open position, furthermore, which results in a final sequence, closed nozzle cap or plastic fitting position for intended storage, furthermore, said nozzle cap or plastic fitting through the structural means of said flip-on and flip-off nozzle cap in a closed position has functional means for avoiding unwanted said liquid chemical drips in said intended storage use,
a false bottle bottom or stand with a first end identified as the end nearest said nozzle cap, furthermore, with structural means on its first end of a first end open, cup like opening with functional means for serving as a drip catching cup, furthermore, with structural means on its second end of a flat surface with functional means for serving as a table stand, furthermore, with first end of said a false bottle bottom or stand structural means of a snap-on and snap-off attachment with functional means to attach to the proximate second end of said real bottle bottom with nozzle,
whereby the invention elements taken as a whole are new art systematically meeting of non-top heavy design either by relatively shortening of invention over-all height, relatively widening of over-all invention width, relatively lowering of over-all center of mass, or relatively making shapes and chosen materials, non-top heavy in over-all weighting versus simply taking prior art, older top dispensing and side dispensing packaging designs and printing labels at a 90 degree angle for bottom dispensing uses,
whereby there is accomplished means for desired, human control in direction and volume dispensing of said liquid chemical, dispensing of said liquid chemical utilizing gravity-fed operation assisted by human squeeze-in actions with highly controlled, liquid chemical dispensing done only through careful tolerances in the openings of said nozzle or narrow throat opening on said real bottle bottom with nozzle,
whereby there is accomplished means for no unwanted dispensing of the non-emulsified liquid which in the normal storage position tends to accumulate with lower density of said non-emulsified liquids causing a floating up to the least gravity action, to said liquid chemical bottle body's normal top or first end, being limited in dispensing actions to said liquid chemical's very low, remaining volume stages,
whereby there is accomplished means for convenient top of table storage in the storage position,
whereby there is accomplished means for desired, human controlled storage of said liquid chemical in a sanitary storage container which is: hermetically sealed during storage for 100% oxidation prevention of said liquid chemical to preserve shelf-life, furthermore, an internal to said entire invention, said liquid chemical is 100% storage sealed for unwanted drips, furthermore, external chlorinated tap water used to wash off said invention is 100% sealed from said liquid chemical, furthermore, external dirt and dust carrying air borne bacteria in bathrooms is 100% sealed from said liquid chemical, furthermore, crawling and flying insects are 100% sealed from said liquid chemical.
[NOTE: Independent claim and all dependent claim, refers exclusively to original patent application (USPTO App. Ser. No. 09/837,314, Dated Apr. 19, 2001) and its original drawings FIGS. 1-4, plus taking advantage of newly discovered, prior art technical material on plastics injection molding plastic fittings, which is dated prior to Apr. 19, 2001 and is submitted with the CIP patent application Information Disclosure Statement (IDS).]

15. A personal sized device for convenient and human highly controlled dispensing of relatively low viscosity, liquid chemicals comprising:
liquid chemical bottle body, furthermore, with a first end identified as the normal storage position's non-dispensing end, furthermore, having no structural bottle first end or top end opening due to assumed filling with functional low viscosity, liquid chemical which does not permanently deform said liquid chemical bottle body upon bottle vacuum production on the human squeeze-in stroke, furthermore, whose second end has a desired diameter built-in opening, furthermore, whose second end has a built-in bottle desired diameter opening, furthermore whose second end is non-structurally integrated with a real bottle bottom with nozzle which provides a nozzle or narrow throat opening, furthermore, which said liquid chemical bottle body is of human squeezable structural material with functional means for squirt out or squeeze-in human hand dispensing action through bottle side inwards internal air pressure upon said liquid chemical with said liquid chemical outflow through any bottle opening in a path of least resistance according to the laws of physics, furthermore, subsequent bottle side internal vacuum production however brief, furthermore, bottle side internal vacuum relief from squeeze-out human hand dispensing action for fresh air inflow from any said liquid chemical bottle structural opening, furthermore, said liquid chemical bottle body has no need for both a first end mechanical attachment for a false bottle bottom or stand as in some relevant prior art, and also no need for positional lugs as in some relevant prior art,
said real bottle bottom with nozzle or narrow throat opening, for carefully controlled and human aimed squirts, furthermore, whose first end is identified by the end nearest said liquid chemical bottle body, furthermore, whose first end is non-structurally integrated with said liquid chemical bottle body with built-in second end opening, furthermore, whose second end has a structural means of a narrow throat opening or nozzle of carefully controlled diameter for functional means of a squeeze-in stroke of desired and human aimed dispensing of said liquid chemical through a human squirting action and a squeeze-out stroke of anti-vacuum fresh air in-flow,
nozzle cap or plastic fitting with a first end identified as the end nearest said real bottle bottom with nozzle, furthermore, with structural means for flip-on and flip-off human action with functional means for dispensing upon a human squeeze-in stroke action, while avoiding unwanted said liquid chemical drips,
a false bottle bottom or stand with a first end identified as the end nearest said nozzle cap, furthermore, with first end, structural attachment means such as a snap-on and snap-off fitting with functional means to attach to the proximate second end of said real bottle bottom with nozzle, furthermore, with structural means on its first end of a cap like opening with functional means for serving as a drip catching cap, furthermore, with structural means on its second end of a flat surface with functional means for serving as a table stand,
whereby the invention elements taken as a whole are new art systematically meeting of non-top heavy design either by relatively shortening of invention over-all height, relatively widening of over-all invention width, relatively lowering of over-all center of mass, or relatively making shapes and chosen materials, non-top heavy in over-all weighting versus simply taking prior art, older top dispensing and side dispensing packaging designs and printing labels on for bottom dispensing,
whereby there is accomplished means for desired, human controlled in direction and volume of said liquid chemical, dispensing of said liquid chemical utilizing gravity-fed operation only through said nozzle on real bottle bottom,
whereby there is accomplished means for no dispensing of non-emulsified liquid which tends to accumulate with floating and lower density on the container's normal top or first end position being limited to said liquid chemical,
whereby there is accomplished means for convenient top of table storage in the storage position,
whereby there is accomplished means for desired, human controlled storage of said liquid chemical in a sanitary storage container which is: hermetically sealed, liquid chemical sealed, external tap water sealed for rinsing off actions, dirt and dust sealed with air-born bacteria, and finally crawling and flying insect sealed.

16. The invention of claim 15 further including that said liquid chemical bottle body is of a non-top heavy shape to prevent tipping over of the bottle.

17. The invention of claim 15 further including that said liquid chemical bottle body has an assumed second end opening, furthermore, said liquid chemical bottle body has a mechanically attached, non-integral structure of said real bottle bottom with nozzle or narrow throat opening, furthermore, said nozzle cap or plastic fitting being structurally a flip-on and flip-off reversible plastic fitting mechanical structure with functional means for reversible external only desired, air intake and desired, air shut-off or hermetic seal to protect the anti-oxidation and anti-pollution, chemical integrity of said liquid chemical, is of a distinct mechanical structure with its own mechanical attachment mechanism, furthermore, said false bottle bottom with stand is also a non-integral structure to all of the aforementioned mechanical structural parts.

18. The invention of claim 15 further including that said real bottle bottom with nozzle or narrow throat opening, has a matching separate structure of said nozzle cap or plastic fitting, furthermore, said nozzle cap or plastic fitting has an openable and closable mechanical structural flip-off and flip-on mechanism, with functional means to dispense liquid chemical in a human controlled manner on said liquid chemical bottle body's squeeze-in action, furthermore, at the conclusion of human dispensing of said liquid chemical, said mechanical structural flip-off and flip-on mechanism can be human placed in the flip-on position with functional means for semi-permanently stopping said liquid chemical gravity flow.

19. The invention of claim 15 further including that said nozzle cap or plastic fitting, may be a structural mechanical, prior art, plastic fitting or plastic closure of various prior art designs, with functional means of low cost, very tight manufacturing tolerances.

20. The invention of claim 15 further including that said false bottle bottom or stand has inside structural geometry of a first end open, drip catching cup-like cap surface, with functional means for catching liquid chemical drips.

21. The invention of claim 15 further including that said false bottle bottom or stand attaches onto said liquid chemical bottle bottom with nozzle which in turn is structurally attached to said liquid chemical bottle body with built-in second end opening, furthermore, said false bottle bottom or stand is structurally reversibly detachable in some mechanical manner using prior art, larger than industry standard, plastic fitting or plastic closure technology, with functional means of very low cost and very high molding tolerance with shrinkage parts.
[NOTE: Independent claim and all dependent claim, refers exclusively to the CIP patent application new technical material and new drawing FIGS. 1-8, plus the original patent application (USPTO App. Ser. No. 09/837,314, Dated Apr. 19, 2001) and its original drawings FIGS. 1-4.]

22. A personal sized device for convenient and human highly controlled dispensing of relative medium viscosity, liquid chemicals comprising:
liquid chemical bottle body or container, furthermore, with a first end identified as the normal storage position's non-dispensing end, furthermore, having no structural bottle first end or top end opening due to assumed filling with functional medium viscosity, liquid chemical which does not permanently deform said liquid chemical bottle body upon bottle vacuum production on the human squeeze-in stroke, furthermore, whose second end has a built-in desired diameter opening, furthermore, whose second end is non-integral structurally with a real bottle bottom with nozzle which provides a nozzle or narrow throat opening, furthermore, which does not cause second end un-controllable dripping from very low viscosity which requires an anti-drip valve, furthermore, which said liquid chemical bottle body is of human squeezable structural material with functional means for squirt out or squeeze-in human hand dispensing action through bottle side inwards internal air pressure upon said liquid chemical with said liquid chemical outflow through any bottle opening in a path of least resistance according to the laws of physics, furthermore, subsequent bottle side internal vacuum production however brief, furthermore, bottle side internal vacuum relief from squeeze-out human hand dispensing action for fresh air inflow from any said liquid chemical bottle structural opening, furthermore, lacking any first end mechanical couplings for a false bottle bottom or stand and also positional lugs for automatic bottling equipment label and print application,
said real bottle bottom with nozzle or narrow throat opening, furthermore, whose first end is identified as the end nearest said liquid chemical bottle body with built-in second end opening, furthermore, said real bottle bottom with nozzle is non-integral structurally with said liquid chemical bottle body with built-in second end opening, furthermore, whose second end has a structural means of a narrow throat opening or nozzle for functional means of a very finely controlled, squeeze-in stroke of desired and human aimed dispensing of said liquid chemical through a human squirting action and a squeeze-out stroke of anti-vacuum fresh air in-flow,
a false bottle bottom or stand with a first end identified as the end nearest said nozzle cap, furthermore, with structural means of a snap-on and snap-off fitting with the proximate second end of said real bottle bottom with nozzle with functional means for attachment, furthermore, having structural means on its first end of a first end open cup-like, cap opening with functional means for serving as a drip catching cap, furthermore, with structural means on its second end of a flat surface with functional means for serving as a table stand,
whereby the invention elements taken as a whole are new art systematically meeting of non-top heavy design either by relatively shortening of invention over-all height, relatively widening of over-all invention width, relatively lowering of over-all center of mass, or relatively making shapes and chosen materials, non-top heavy in over-all weighting versus simply taking prior art, older top dispensing and side dispensing packaging designs and printing labels on for bottom dispensing,
whereby there is accomplished means for desired, human controlled in direction and volume of said liquid chemical, dispensing of said liquid chemical utilizing gravity-fed operation only through said nozzle on real bottle bottom,
whereby there is accomplished means for no dispensing of non-emulsified liquid which tends to accumulate with floating and lower density on the container's normal top or first-end position being limited to said liquid chemical,
whereby there is accomplished means for convenient top of table storage in the storage position,
whereby there is accomplished means for desired, human controlled storage of said liquid chemical in a sanitary storage container which is: hermetically sealed, liquid chemical sealed, external tap water sealed for rinsing off actions, dirt and dust sealed with air-born bacteria, and finally crawling and flying insect sealed.

23. The invention of claim 22 further including that said liquid chemical bottle body is of a non-top heavy shape to prevent tipping over of the bottle.

24. The invention of claim 22 further including that said liquid chemical bottle body with built-in second end opening, has a non-integral structure of mechanically attached said real bottle bottom with nozzle or narrow throat opening, as opposed to the entirely separate structure of said false bottle bottom or stand.

25. The invention of claim 22 further including that said real bottle bottom with nozzle or narrow throat opening, has a nozzle cap or plastic fitting, which has an openable and closable mechanical structural flip-off and flip-on mechanism with functional means to dispense liquid chemical in a human controlled manner on said liquid chemical bottle body's squeeze-in action, furthermore, at the conclusion of human dispensing of said liquid chemical, said mechanical structural flip-off and flip-on mechanism can be human placed in the flip-on position with functional means for semi-permanently stopping said liquid chemical gravity flow.

26. The invention of claim 22 further including that said nozzle cap or plastic fitting, may be a structural mechanical, prior art, plastic fitting or plastic closure of various prior art designs, with functional means of low cost, very tight manufacturing tolerances.

27. The invention of claim 22 further including that said false bottle bottom or stand has inside structural geometry of a drip catching cap surface, with functional means for catching liquid chemical drips.

28. The invention of claim 22 further including that said false bottle bottom or stand attaches onto the separate structure of said real bottle bottom with nozzle, furthermore, said liquid chemical bottle body with built-in second end opening is structurally independent of the other parts, furthermore, said false bottle bottom or stand is structurally reversibly detachable in some mechanical manner using prior art, larger than industry standard, plastic fitting or plastic closure technology, with functional means of very low cost and very high molding tolerance with shrinkage parts.
